(19) United States
(12) Patent Application Publication
(10) Pub. No.: US 2026/0135013 A1
(43) Pub. Date: May 14, 2026

(54) A HERALDED ENTANGLEMENT PROTOCOL FOR OPTICALLY-ADDRESSED QUBITS

(71) Applicant: California Institute of Technology, Pasadena, CA (US)

(72) Inventors: Andrei Ruskuc, Pasadena, CA (US); Chun-Ju Wu, Pasadena, CA (US); Sophie Hermans, Pasadena, CA (US); Andrei Faraon, Pasadena, CA (US)

(73) Assignee: California Institute of Technology, Pasadena, CA (US)

(21) Appl. No.: 18/912,115

(22) Filed: Oct. 10, 2024

Related U.S. Application Data
(60) Provisional application No. 63/543,366, filed on Oct. 10, 2023.
(60) Provisional application No. 63/705,663, filed on Oct. 10, 2024.

(51) Int. Cl. G21K 1/30; G06N 10/40

(52) U.S. Cl. CPC G21K 1/30; G06N 10/40

(57) ABSTRACT

A computer system for implementing a protocol comprising instructing one or more attempts at entanglement of physical qubits to form entangled qubits; recording an absence of a detection of a photon or the detection of a single photon heralding the entanglement, the detection at one or more detectors in response to a combination of photons emitted from the physical qubits in response to the attempt; instructing application of a dynamic decoupling sequence to the physical qubits in real time with the detection to compensate for dephasing caused by non-static optical inhomogeneity of the physical qubits associated with stochastic emission of photons from the physical qubits; if necessary, instructing application of a phase compensation to the physical qubits during a rephasing period to compensate for static inhomogeneity of the qubit levels in the different physical qubits; and instructing readout and/or utilization of one or more of the entangled qubits.

### CROSS REFERENCE TO RELATED APPLICATIONS

This application claims the benefit under 35 U.S.C. Section 119 (e) of:
U.S. Provisional Application No. 63/543,366 filed Oct. 10, 2023, by Andrei Ruskuc, Chun-Ju Wu, Sophie Hermans, and Andrei Faraon, entitled “A HERALDED ENTANGLEMENT PROTOCOL FOR OPTICALLY-ADDRESSED QUBITS,” (CIT-8972-P2);
U.S. Provisional Application No. 63/705,663 filed Oct. 10, 2024, by Andrei Ruskuc, Chun-Ju Wu, Sophie Hermans, and Andrei Faraon, entitled “A HERALDED ENTANGLEMENT PROTOCOL FOR OPTICALLY-ADDRESSED QUBITS,” both of which applications are incorporated by reference herein.

This application is related to U.S. Utility patent application Ser. No. 17/899,291 filed Aug. 30, 2022, by Andrei Ruskuc, Joonhee Choi, Chun-Ju Wu, and Andrei Faraon, entitled “NUCLEAR SPIN WAVE QUANTUM REGISTER FOR SOLID STATE QUANTUM NETWORK NODES,” which application claims the benefit under 35 USC 119 (e) of co-pending and commonly assigned U.S. Provisional Patent Application Ser. No. 63/238,624 filed Aug. 30, 2021, by Andrei Ruskuc, Joonhee Choi, Chun-Ju Wu, and Andrei Faraon, entitled “NUCLEAR SPIN WAVE QUANTUM REGISTER FOR SOLID STATE QUANTUM NETWORK NODES,” (CIT-8694-P), both of which applications are incorporated by reference herein.

### STATEMENT REGARDING FEDERALLY SPONSORED RESEARCH AND DEVELOPMENT

This invention was made with government support under Grant No. FA9550-22-1-0178 awarded by the Air Force and under Grant No(s) PHY2210570 & PHY1125565 awarded by the National Science Foundation. The government has certain rights in the invention

### BACKGROUND OF THE INVENTION

### 1. Field of the Invention

The present disclosure relates to methods for heralding entanglement and systems and devices using and implementing the same.

### 2. Description of the Related Art

Photon-based entanglement distribution is a critical requirement for quantum networking, enabling secure communication and distributed quantum computing. Solid-state defects have emerged as leading candidates for network nodes due to their compatibility with scalable device engineering and the presence of nuclear spins for local quantum processing. Key milestones toward this application have been demonstrated using single ¹⁷¹Yb ions in YVO₄, coupled to a nanophotonic cavity. These include coherent optical and spin control, long-term quantum information storage, single-shot readout and a nuclear ancilla qubit. What is needed however, are improved methods for heralding entanglement of qubits. The present disclosure satisfies this need.

### SUMMARY OF THE INVENTION

The present disclosure demonstrates entanglement of spectrally distinguishable qubits. This is achieved with a single photon heralding protocol and frequency erasure via high-resolution detection of the photon emission time. The random quantum phase generated by the stochastic emission process is corrected in real-time, enabling preparation of a deterministic spin-entangled state. The narrow optical inhomogeneous distribution of these emitters enables any-to-any connectivity in a scalable fashion. Furthermore, we implement an optical dynamical decoupling protocol to boost the entanglement rate. These results showcase a qubit platform and entanglement heralding protocol useful for implementation in a quantum networking or quantum communications applications.

In one embodiment, the dynamic decoupling comprises application of pulses imparting a pre-compensated amount of phase constructed such that any phase accumulated during a second half of a given heralding period is cancelled by phase accumulated during a first half of a subsequent heralding period.

In another embodiment, the heralded entanglement between pairs of optically addressed qubits that utilizes a novel procedure termed ‘dynamic rephasing’. By dynamically adjusting the delay time in a dynamical decoupling pulse sequence, a random phase associated with stochastic photon emission can be robustly counteracted. This protocol simultaneously addresses three commonly encountered issues with experimental approaches, namely: low photon detection efficiency, static optical frequency inhomogeneity and dynamic optical frequency inhomogeneity (also termed non-lifetime limited coherence).

Illustrative embodiments demonstrate entanglement of two spectrally distinguishable 171Yb qubits in a single cavity. This is achieved with a single photon heralding protocol and frequency erasure via high-resolution detection of the photon emission time. The random quantum phase generated by the stochastic emission process is corrected in real-time, enabling preparation of a deterministic spin-entangled state. The narrow optical inhomogeneous distribution of these emitters (200 MHz) enables any-to-any connectivity in a scalable fashion. Furthermore, we implement an optical dynamical decoupling protocol to boost the entanglement rate. These results showcase single rare-earth ions as a promising platform for the quantum internet.

Further results are presented for a two node network consisting of several rare-earth ions coupled to nanophotonic cavities [25-31]. This is accomplished with a protocol that entangles distinguishable ^{171Y}b ions through frequency-erasing photon detection combined with real-time quantum feedforward. This method is robust to slow optical frequency fluctuations occurring on timescales longer than a single entanglement attempt: a universal challenge amongst solid state emitters. We demonstrate the enhanced functionality of these multi-emitter nodes in two ways. First, we mitigate bottlenecks to the entanglement distribution rate through multiplexed entanglement of two remote ion pairs [32,33]. Secondly, we prepare multipartite W-states comprising three distinguishable ions as a useful resource for advanced quantum networking protocols [34,35]. These results lay the groundwork for scalable quantum networking based on rare-earth ions.

Illustrative embodiments include, but are not limited to, the following.
1. A system:
   a plurality of physical qubits each having an energy level structure comprising a ground state comprising a first level and a second level; and an excited state, wherein the physical qubits each have qubit levels comprising the first level and the second level of the ground state;
   one or more sources of a first electromagnetic pulses (e.g., microwave pulses) tunable for coherently manipulating the qubits by driving a first transition between the first level and the second level;
   one or more sources of second electromagnetic pulses comprising optical pulses tunable for coherently manipulating the qubits by driving a second transition from the first level or the second level to the excited state; and
one or more photodetectors coupled to the physical qubits for detecting a single photon in response to photons emitted from the excited states of the different physical qubits with a timing resolution at least 10 times shorter than 1/Δf where Δf is the largest frequency separation between the second transitions of the physical qubits;
a circuit operable to control execution of a protocol, the protocol comprising control of a sequence, timing, a phase and a duration of the pulses outputted from the sources in real time with detection of the single photons, and the protocol further comprising:
(a) one or more initialization pulses comprising at least one of the first electromagnetic pulses or the second electromagnetic pulses, for initializing each of the qubits into the first level or the second level;
(b) a plurality of the first electromagnetic pulses, each of the first electromagnetic pulses applied simultaneously to the first transition of a different one of the physical qubits so as to prepare an imbalanced superposition of the first level and the second level;
(c) a plurality of the second electromagnetic pulses, each of the second electromagnetic pulses applied simultaneously to a different one of the plurality of physical qubits to resonantly excite the second transition from the ground state to the excited state in each of the physical qubits in an attempt to entangle the different qubits to form entangled qubits;
(d) (i) recording detection of the single photon at one of the photodetectors to herald entanglement of a set of the physical qubits with an appropriate time stamp (t₀) during a heralding period, wherein the photodetector outputs the detection time t₀ of the single photon in response to the second pulses which may each have a predetermined transition frequency difference Δ\tilde{ω} from the second transition frequencies, or
   (ii) indicating no photon is detected at the of the photodetectors;
(e) a dynamic decoupling sequence comprising at least one of the first electromagnetic pulses and at least one of the second electromagnetic pulses applied in real time based on the previous recording of the time stamp to compensate for dephasing caused by non-static optical inhomogeneity of the physical qubits associated with stochastic emission of the photons;
(f) determining a quantum phase of a prepared Bell state φ=Δ\tilde{ω}t₀ to ascertain whether a correction of the quantum phase resulting from the predetermined transition frequency differences between the plurality of the physical qubits is necessary;
(g) if the correction is necessary, instructing a phase compensation during a rephasing period comprising application of a differential z-rotation (phase shift) of the physical qubits by an amount φ, wherein the correction is determined and applied within a coherence time of the physical qubits and:
   (i) when the physical qubits are in the same device, the phase compensation comprises application of at least one of the first electromagnetic pulse or the second electromagnetic pulse, or
   (ii) when the physical qubits are in different nodes, the phase compensation comprises a phase change of the first electromagnetic pulses; and
(h) instructing readout and/or utilization of the entangled qubits.
2. The system of clause 1, comprising:
   a plurality of nodes each comprising a different one of the set of the physical qubits to be entangled;
   one or more links comprising one or more optical fibers connecting the nodes, each of the links further comprising a coupler or beamsplitter for combining photons emitted from the excited states in a different one of the nodes; and
   the one or more photodetectors positioned after the coupler or beamsplitter for detecting the single photon in response to the combination of the photons emitted from the different nodes.
3. The system of clause 1 for multiplexing entanglement of N sets of the physical qubits, the N sets of the physical qubits comprising second transitions with different transition frequencies, where N is an integer greater than or equal to 2 and the protocol further comprises:
   initializing the physical qubits in the N sets using steps (a) and (b);
   for 2≤i≤N, exciting the second transitions in the ith one of the sets using step (c) in an attempt to entangle the ith one of the sets in an ith entangled state and performing a spin dynamical decoupling on the physical qubits between the exciting of the ith one of the sets and the next one of the sets; and
   sequentially performing the step (d)-(f) on one or more of the sets until step (d) heralds the entanglement of one of the sets and instructing the quantum network in step (h) to use the entangled state of the one of the sets for which the step (d) heralds the entanglement, thereby increasing a rate at which the entangled qubits can be distributed in the network.
4. The system of clause 1, wherein the entangled qubits comprise more than two physical qubits and the protocol in steps (a)-(h) is used to herald the entanglement of the entangled qubits in a W state and comprising more than two physical qubits.
5. The system of clause 1, wherein the dynamic decoupling sequence comprises application of the pulses imparting a pre-compensated amount of phase constructed such that any phase accumulated during a second half of a given heralding period is cancelled by phase accumulated during a first half of a subsequent heralding period.
6. The system of clause 1, wherein the dynamic decoupling sequence applied to each of the physical qubits comprises:

$${[ τ - \tilde{π} - 2 τ - \tilde{π} - τ ]}^{N}$$

where \tilde{π} comprises the second electromagnetic pulse comprising a generalised π pulse tuned between the level in which the physical qubit was initialized and the excited state and applied simultaneously to each of the plurality of physical qubits, τ is an arbitrarily chosen decoupling time, a wait time between consecutive \tilde{π} pulses is 2τ, and N the number of times the dynamic decoupling sequence is repeated;
the heralding period is after odd numbers of the \tilde{π} pulses and the photodetector outputs the detection time t₀ of the single photon measured relative to a center of the heralding period, so that t₀∈[−τ,τ] for the second electromagnetic pulses having a predetermined transition frequency difference Δω=ω_{A,2}−ω_{A,1}−ω_{f,2}+ω_{f,1} where ω_{x,N} is the angular frequency for transition x of physical qubit N.
7. The system of clause 6, wherein generalized the \tilde{π} pulse comprises one of the second electromagnetic pulses exciting the second transition followed by one of the first electromagnetic pulses exciting the first transition followed by another one of the second electromagnetic pulses exciting the second transition and wherein all of the pulses are pi pulses.
8. The system of clause 6, wherein the excited state comprises a first excited level and a second excited level.
9. The system of clause 8, further comprising third electromagnetic pulses comprises pulses tunable to excite a third transition between the first excited level and the second excited level in each of the physical qubits, and wherein, for each of the physical qubits:
the generalized \tilde{π} pulse comprises:
one of the second electromagnetic pulses exciting the second transition followed by application of M repetitions of the first and third electromagnetic pulses simultaneously applied to excite the first and third transitions, with time separation between the repetitions of 2T_{DD} and wherein a total duration 2MT_{DD} is longer than the optical lifetime of the excited state and M is odd; and
followed by one of the second electromagnetic pulses applied to the excite the second transition; and
wherein all the pulses are pi pulses.
10. The system of clause 1, wherein:
the single photon is detected during the heralding period of duration τ and are emitted randomly (according to an exponential distribution), with corresponding stochastic measurement time t₀ such that t₀∈[0,τ]; and
the dynamic decoupling sequence comprises applying rephasing pulses in real time and for a duration that depends on t₀.
11. The system of clause 1, wherein the dynamic decoupling sequence comprises:
a plurality of the first electromagnetic pulses applied simultaneously to a excite the first transitions of the plurality of the physical qubits so that the coherence is rephased for a duration (τ−t₀) in each of the physical qubits;
followed by the second electromagnetic pulses applied simultaneously to the second transitions of the plurality of the physical qubits, thereby transferring population from the ground state to the excited state in each of the physical qubits; and
after waiting for the duration t₀, applying the second electromagnetic pulses simultaneously to the second transitions so as to transfer population from the excited state back to ground state in each of the physical qubits, and
wherein all the pulses comprise pi pulses.
12. The system of clause 1, wherein the dynamic decoupling sequence comprises:
at least one of the first electromagnetic pulses between two of the second electromagnetic pulses or
one or more of the first electromagnetic pulses followed by at least two of the second electromagnetic pulses separated in time by t₀.
13. The system of clause 1, wherein the physical qubits are each located in physically separate devices or nodes and the phase is corrected by changing a phase of the first electromagnetic pulses independently applied to the qubits.
14. The system of clause 1, wherein the plurality of the qubits are located in the same device and the phase is corrected by application of the second electromagnetic pulses as to induce an AC stark shift of the second transitions.
15. The system of clause 1, wherein the dephasing corrected by the dynamic decoupling sequence are caused by frequency differences between the pulses outputted from different ones of the sources used to excite the different physical qubits.
16. A quantum network or quantum repeaters comprising the system of clause 1, wherein each of the physical qubits in the set are at different locations in the quantum network.
17. The system of clause 1, wherein the physical qubits comprise neutral trapped atoms, trapped ions, defects in a solid state host lattice, quantum dots, molecules, rare earth ions, or superconducting qubits.
18. A computer system for implementing a protocol in a quantum network or quantum communication system, comprising:
a computer having a memory;
a processor executing on the computer;
the memory storing a set of instructions, wherein the set of instructions, when executed by the processor cause the processor to perform operations comprising execution of a protocol comprising:
instructing one or more attempts at entanglement of physical qubits to form entangled qubits;
during a heralding period, recording an absence of a detection of a photon or the detection of a single photon heralding the entanglement, the detection at one or more detectors in response to a combination of photons emitted from the physical qubits in response to the attempt;
instructing application of a dynamic decoupling sequence to the physical qubits in real time with the detection to compensate for dephasing caused by non-static optical inhomogeneity of the physical qubits associated with stochastic emission of photons from the physical qubits;
if necessary, instructing application of a phase compensation to the physical qubits during a rephasing period to compensate for static inhomogeneity of the qubit levels in the different physical qubits; and instructing readout and/or utilization of one or more of the entangled qubits.
19. The system of clause 18, wherein the protocol:
performs entanglement multiplexing comprising instructing the attempts at entanglement of 2 or more entangled qubits and only instructing readout and/or utilization of a first one of the entangled qubits for which the detection of the single photon heralds the entanglement; and/or
instructs the entanglement of more than 2 physical qubits.
20. The system of clause 18 or 19 further including the system of any of the clauses 1-17.
21. A method for heralding entanglement in a quantum network or quantum communication system, comprising:
attempting entanglement of physical qubits to form entangled qubits;
during a heralding period, recording an absence of a detection of a photon or the detection of a single photon heralding the entanglement, the detection at one or more detectors in response to a combination of photons emitted from the physical qubits in response to the attempt;
applying a dynamic decoupling sequence to the physical qubits in real time with the detection to compensate for dephasing caused by non-static optical inhomogeneity of the physical qubits associated with stochastic emission of photons from the physical qubits;
if necessary, instructing application of a phase compensation to the physical qubits during a rephasing period to compensate for static inhomogeneity of the qubit levels in the different physical qubits; and
reading out a state of the entangled qubits and/or instructing use of the entangled qubits in a quantum networking or quantum communication application.
22. The method of clause 21 performing the steps of or implemented using the system of any of the clauses 1-21.

### BRIEF DESCRIPTION OF THE DRAWINGS

The patent or application file contains at least one drawing executed in color. Copies of this patent or patent application publication with color drawing(s) will be provided by the Office upon request and payment of the necessary fee

Referring now to the drawings in which like reference numbers represent corresponding parts throughout:

FIG. 1: Energy level structure for the heralded entanglement protocol. a) The minimal required level structure. b) The energy level structure required for the advanced \tilde{π} pulses

FIG. 2: Entanglement protocol detail. a) An outline of the entanglement protocol pulse sequence. b) The detailed pulse sequence used to implement a basic \tilde{π} pulse. c) The detailed pulse sequence used to implement an advanced \tilde{π} pulse. d) two photodetectors positioned behind a beamsplitter for combining photons from separate qubits in separate devices in order to herald entanglement. e) single photodetector for detecting photons from qubits in the same device in order to herald entanglement.

FIG. 3: Simulations of entanglement protocols. a) Fidelity and efficiency of a basic entanglement protocol plotted against the heralding window size. Note that the entangled state fidelity decays with a T₂*timescale, while the efficiency saturates with a T₁ timescale. b) Fidelity and efficiency of the proposed dynamically decoupled entanglement protocol plotted against the total heralding timescale. Note that they both exhibit decays with time constant T₁.

FIG. 4a. Protocol for preparing and heralding entanglement with no feedforward

FIG. 4b. Measurement of entanglement (and comparison to simulation) using the protocol in FIG. 4a.

FIG. 4c. Coherence metric as a function of photon arrival time.

FIG. 4d. ion fluorescence spectrum showing detuning of the optical transition of two different qubits.

FIGS. 4e and 4f. Measurement of entanglement (and comparison to simulation with readout error corrected using the coherence metric.

FIG. 5a. Protocol for preparing and heralding entanglement with feedforward and AC stark shift to compensate for static inhomogeneity.

FIG. 5b. Coherence metric for different situations.

FIG. 5c. Measurement of entanglement (and comparison to simulation) using protocol with feedforward.

FIG. 6: Photon detection time resolved coherence of different entanglement protocols. a) Basic Ramsey protocol, note one-sided decay with T₂*-dependent timescale. b) Pre-compensated rephasing protocol with three different phase compensation time periods: τ=150, 450, 750 ns. Note the corresponding shift in rephasing time. Coherence decay is now two-sided but still limited by T₂*. c) Dynamic rephasing protocol: the coherence decay now depends on the ion lifetime.

FIG. 7: Upper panel shows the coherence of the entangled state vs photon arrival time. Note that the Bell State oscillates between |ψ₊ [symbol] and |ψ⁻ [symbol] at the static optical drive frequency difference. In the lower panel, the photon measurement time is fed-forward and used apply a differential z-rotation before readout. The entangled state is now deterministically |ψ⁺ [symbol] .

FIG. 8: Maximum likelihood quantum state tomography of the two-ion entangled state. We perform population measurements in the XX, YY, ZZ, XY, YX, ZY, YZ, ZX and XZ bases and perform maximum likelihood quantum state tomography to extract this density matrix. The photon acceptance window was set to 500 ns leading to an entanglement rate of 3.1 Hz and fidelity of 0.723±0.007.

FIG. 9. Schematic of a quantum network link based on multiple ^{171Y}b qubits in nanophotonic cavities. a, Individual ¹⁷¹Yb ions in YVO₄ have an optical transition (|1 [symbol] ↔|e [symbol] ) at 984.5 nm for readout and entanglement heralding, and a hyperfine spin transition (|0 [symbol] ↔|1 [symbol] ) at 2π×675 MHz for long-term memory, referred to as the qubit. Photonic emission entangled with ^{171Y}b qubits in two remote nanophotonic cavities is interfered and measured at a central beamsplitter, forming a quantum network link. b, Each node contains an ensemble of ^{171Y}b ions with ≈2π×200 MHz inhomogeneous optical frequency distribution, as shown in the normalized photoluminescence excitation spectra. In this work, four spectrally-resolved ions indicated with arrows are utilized. c, We achieve scalable remote entanglement distribution with heralding protocols that compensate for static shifts and dynamic fluctuations in ions' optical transition frequencies. For each heralding event, this is achieved by precisely measuring the photon emission time, t₀, and applying a measurement-conditioned feedforward operation, thus retrieving pure entangled states. d, We extend these protocols to include multiple qubits per node. First, we utilize temporal multiplexing across two remote ion pairs to increase the entanglement distribution rate. Then, we utilize the expanded local Hilbert space of each node to prepare W states comprising three frequency-resolved qubits. ₁₂₀ platforms [26,44,45].

FIG. 9. Experimental setup for remote entanglement generation. e, Nanophotonic cavities (Devices 1 and 2) are cooled by a ³He cryostat to 0.5 K. Optical control of ions' A and F transitions is achieved using lasers L1, L3 and L4 which are modulated by a series of acousto-optic modulator (AOM) setups for pulse generation and frequency tuning (AOM 3-8). All lasers are frequency-locked to a reference cavity. Photons exiting the devices are combined on a polarizing beamsplitter (PBS 1), AOM 9 routes photons towards the Detection setup (depicted in f). Heterodyne phase measurement of the optical path difference between Devices 1 and 2 is achieved using light pulses from laser L2 which are routed by AOM 9 to an avalanche photodiode (APD) for measurement. f, There are three possible detection setups used for entanglement heralding and readout. Setup 1 consists of a single superconducting nanowire single photon detector (SNSPD) and heralds entanglement of two ions within the same device. Setup 2 uses a single SNSPD combined with a time-delayed interferometer to entangle two ions with different optical frequencies located in separate devices. Setup 3 uses two SNSPDs for entanglement experiments involving more than two ions. g, Setups AOM 5 and 6 each consist of a single AOM in double pass configuration and enable simultaneous, phase-stable driving of ions in the same device. h, Setups AOM 7 and 8 consist of three acousto-optic modulators, each in double pass configuration, enabling pulse generation with a 2π×600 MHz optical frequency tuning range. i, Microwave setup for driving the ground and excited state spin transitions at ≈2π×675 MHz and ≈2π×3.37 GHz, respectively. The ground state (qubit) pulses are generated by heterodyne modulation combined with filters for image rejection before being amplified, combined with the excited state pulses on a diplexer and sent to the device.

FIG. 10. Remote entanglement generation between two ¹⁷¹Yb qubits. a, During entanglement, a photon detection at random time t₀ heralds the two-qubit state |ψ(t₀) [symbol] =1/\sqrt{2}(|10 [symbol] +e^{-iφ(t}^{₀}⁾|01 [symbol] ) with stochastic phase φ(t₀)=Δω₁₂t₀ depending on t₀ and the fluctuating optical frequency difference, Δω₁₂ (Bloch sphere (1)). Next, a dynamic rephasing sequence mitigates the contribution from frequency fluctuations, yielding a residual phase Δω₁₂ to, where Δω₁₂ is the frequency difference between lasers used to drive the ions (Bloch sphere (2)). We compensate this phase, leading to a deterministic Bell state, 1/\sqrt{2}(|01 [symbol] +|10 [symbol] ), independent of t₀ (Bloch sphere (3)). Operations depend on the photon arrival time and are dynamically adjusted via real-time feedforward. b-d, Entangled state coherence between Ions 1 and 2 is correlated with photon measurement time, t₀, at three different points (1) in b, (2) in c and (3) in d, see FIG. 10a). Panel (1) in b: without phase correction the coherence exhibits parity oscillation at the optical frequency difference, ≈2π×31 MHz, and decay from optical frequency fluctuation. Panel (2) in c: after dynamic rephasing, coherence is extended and oscillates at the static frequency difference between the lasers used to drive Ions 1 and 2, Δω₁₂. Panel (3) in d: residual phase variation, φ(t₀)=Δω₁₂t₀, is compensated yielding a deterministic Bell state. e, Quantum state tomography of the phase-corrected Bell state with 500 ns photon acceptance window yields a fidelity and rate of [symbol] =0.723±0.007 and 3.1 Hz respectively. Populations in 9 two-qubit Pauli bases are measured for the tomography; XX, YY and ZZ results are plotted in addition to the absolute values of the resulting density matrix, |ρ|. f, As the acceptance window is varied from 100 ns to 2900 ns, the entanglement fidelity and rate range from F=0.758+/−0.016 and R=0.73 Hz, to F=0.588+/−0.004 and R=9.4 Hz, respectively. g, The entangled state is stored using XY-8 dynamical decoupling with 1/e memory time T2, Bell=9.1+/−0.4 ms. In b-d solid lines are from simulations, in f and g they are fits to exponential decays.

FIG. 11. Multiplexed entanglement rate enhancement using two pairs of ¹⁷¹Yb spin qubits. a, After initializing all four ions, two consecutive entanglement attempts are performed, first on Pair 2 (consisting of Ions 3 and 4), then on Pair 1 (consisting of Ions 1 and 2). If either entanglement attempt is successful, the sequence proceeds exclusively with the corresponding ion pair. We apply the dynamic rephasing and phase compensation protocols, before reading out the two-qubit state parity in the X, Y or Z bases. Since the ion initialization time bottlenecks our entanglement rate, parallelizing this step across all four ions leads to delivery of entangled states at an enhanced rate. A detailed experiment sequence can be found in Extended Data FIG. 9. b, As the photon acceptance window is varied from 100 ns to 2900 ns, the entanglement rate and Bell state fidelity for the multiplexed protocol range from [symbol] =1.6 Hz and [symbol] =0.714±0.008 to [symbol] =23 Hz and [symbol] =0.571±0.002, respectively (purple markers). Compared to optimized (non-multiplexed) entanglement experiments for Pair 1 or Pair 2 (blue and green markers, respectively), we observe similar fidelities for the multiplexed protocol which increases the rate by a factor of ≈1.9. Solid lines are fits to exponential decays.

FIG. 12. Tripartite W-state generation between three ¹⁷¹Yb spin qubits. a, W states are prepared on three distinguishable ions, whereby Ions 1 and 3 are co-located in Device 1 and Ion 2 is in Device 2. Cᵢⱼ is the two-body qubit coherence between Ions i and j. b, These tripartite W states are generated using a similar single-photon protocol as FIG. 10. Each ion is prepared in a weak superposition state, subsequently, all three ions are optically excited. Entanglement is heralded by the detection of a single photon at time t₀, thereby preparing the tripartite W state |ψ(t₀) [symbol] =1/\sqrt{3}(|100 [symbol] +|010 [symbol] e^{-iΔω}^{₁₂}^{t}^{₀}+|001 [symbol] e^{-iΔω}^{₁₃}^{t}^{₀}) where Δωᵢⱼ is the fluctuating optical frequency difference between Ions i and j. We dynamically rephase optical and spin decoherence on all three ions leading to |ψ(t₀) [symbol] =1/\sqrt{3}(|100 [symbol] +|010 [symbol] e^{-i\tilde{ω}}^{₁₂}^{t}^{₀}+|001 [symbol] e^{-i\tilde{Δ}ω}^{₁₃}^{t}^{₀}) with Δωᵢⱼ the frequency difference between lasers used to drive Ions i and j. The two to-dependent stochastic phases are compensated in real-time using single qubit Z-rotations based on a combination of a drive phase shift and an AC stark shift of the qubit transitions (see Methods Section E and ref. [40]). Ultimately, this generates a canonical W state with the form |W [symbol] =1/\sqrt{3}(|100 [symbol] +|010 [symbol] +|001 [symbol] ). c, After performing the entire protocol, we measure the quantum state in all 27 three-qubit Pauli bases along X, Y and Z. With a 300 ns photon acceptance window we measure an entanglement rate of R=2.0 Hz, we use maximum likelihood quantum state tomography to extract the density matrix with a measured fidelity of [symbol] =0.592±0.007.

FIG. 13. Flowchart illustrating a method and system according to one or more embodiments.

FIG. 14. Flowchart illustrating a method and system according to another embodiment.

FIG. 15. Flowchart illustrating a method and system according to another embodiment.

FIG. 16. Hardware Environment embodiment.

FIG. 17. Network Environment embodiment.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Technical Description

The present disclosure reports on a novel protocol for entangling pairs of optically addressed qubits. Remote entanglement is a key feature of quantum networking, providing a way to entangle two quantum systems without relying on local interactions-relying instead on interference of travelling photons at some central location. These photons are emitted by stationary qubits which are the nodes in the network. Our protocol provides key functionality towards realizing large-scale quantum networking.

Moreover, the protocol simultaneously addresses three major imperfections found in quantum network nodes consisting of optically addressed qubits:
1. Low photon collection or detection efficiency.
2. Static optical inhomogeneity (i.e. some large static frequency difference between the two qubits' optical transitions)
3. Dynamic optical inhomogeneity of the qubits' optical frequencies (i.e. some fluctuation of the optical frequency difference, usually smaller than the static inhomogeneity, often termed non lifetime-limited coherence).

### Energy Level Structures

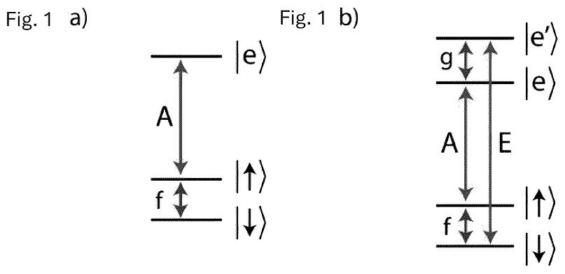

FIG. 1a shows the minimal energy level structure required for implementing our protocol. It consists of a long-lived quantum memory in the ground state, consisting of two levels labelled |↑ [symbol] and |↓ [symbol] (the notation “up’ and ‘down’ does not require spin states, the notation is merely used to differentiate between to level). The transition (|↑ [symbol] ↔|↓ [symbol] , labelled f) is addressed via microwave driving, although levels with other transition frequencies (e.g., RF, terahertz, infrared) could be used. The structure also consists of a single optically excited state (labelled |e [symbol] ) which is connected to one of the ground state levels by an optical transition (labelled A) which can be selectively addressed/excited.

For the sake of this illustrative example, we will assume that the transition |↑ [symbol] ↔|e [symbol] is selectively addressed. Emission from the optically excited state needs to preferentially occur into the |↑ [symbol] level. This can occur either via intrinsic properties of the qubit (i.e. transition |↓ [symbol] ↔|e [symbol] is forbidden) or via selective enhancement of the |↑ [symbol] ↔|e [symbol] transition (e.g. via the Purcell Effect).

FIG. 1b shows an expanded energy level structure which is required for an advanced version of our protocol (discussed below). It consists of an additional excited state energy level (labelled |e′ [symbol] ) which preferentially decays via an optical transition (labelled E) to the ground state |θ [symbol] . Furthermore, the two optically excited levels |e [symbol] and |e′ [symbol] are connected via a microwave transition, labelled g.

Note: throughout this text, transitions associated with each of the two qubits being entangled will be indicated with subscripts 1 and 2, respectively. When denoting two qubit states, the symbols within a ket will be ordered (i.e. qubit 1 first, qubit 2 second) and subscripts will be dropped.

### First Example Protocol Outline

The protocol for heralding entanglement proceeds as follows:
1. The two qubits are each initialised into a specific ground state level, for the sake of example we will assume level |↓ [symbol] .
2. A microwave pulse is applied to the ground state transition, f, thereby preparing an imbalanced superposition of the two levels |↓ [symbol] and |↑ [symbol] . Specifically, each qubit is prepared in the state:

$$\sqrt{α} \vert ↓ 〉 + \sqrt{1 - α} \vert ↑ 〉$$

Such that the two qubit state is given by:

$$α \vert ↓ ↓ 〉 + \sqrt{α ( 1 - α )} [ \vert ↑ ↓ 〉 + \vert ↓ ↑ 〉 ] + ( 1 - α ) \vert ↑ ↑ 〉$$

3. Each of the two qubits is optically excited (i.e. resonant optical π pulses are simultaneously applied to transition A₁ of qubit 1 and A₂ of qubit 2). This yields the state:

$$α \vert ↓ ↓ 〉 + \sqrt{α ( 1 - α )} [ \vert e ↓ 〉 + \vert ↓ e 〉 ] + ( 1 - α ) \vert ee 〉$$

4. A periodic dynamical decoupling sequence is now applied:

$${[ τ - \tilde{π} - 2 τ - \tilde{π} - τ ]}^{N}$$

The symbol \tilde{π} corresponds to a generalised I pulse between the levels |↓ [symbol] and |e [symbol] and needs to be applied simultaneously to each of the two qubits. The wait time between consecutive \tilde{π} pulses is 2τ. The base sequence period is repeated N times. Free evolution periods of duration 2τ are classified into two distinct types. Periods that occur after odd numbered \tilde{π} pulses are termed ‘heralding periods’, periods after even numbered pulses are termed ‘rephasing periods’. During rephasing periods the quantum state is:

$$α \vert ↓ ↓ 〉 + \sqrt{α ( 1 - α )} [ \vert e ↓ 〉 + \vert ↓ e 〉 ] + ( 1 - α ) \vert ee 〉$$

During heralding periods the quantum state is:

$$α \vert ee 〉 + \sqrt{α ( 1 - α )} [ \vert ↓ e 〉 + \vert e ↓ 〉 ] + ( 1 - α ) \vert ↓ ↓ 〉$$

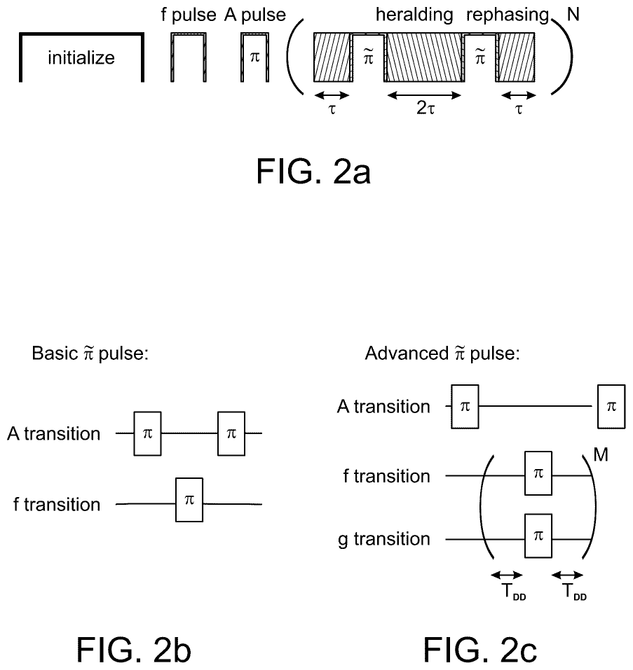

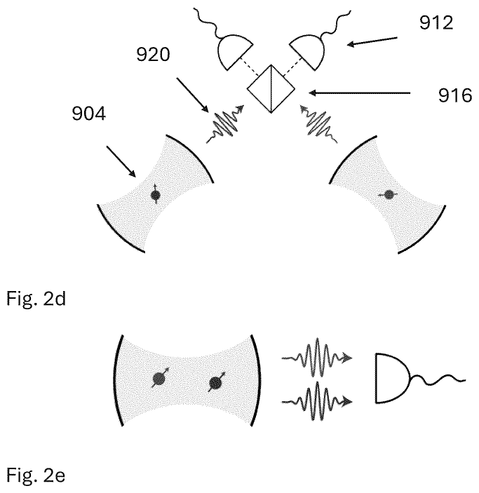

See FIG. 2a for more detail.
5. Entanglement is heralded by detection of a single photon during a heralding period. At this point the dynamical decoupling sequence is terminated (via real-time feedforward control of the experiment). The two-qubit state at this point is given by:

$$\frac{1}{\sqrt{2}} [ \vert ↑ ↓ 〉 + \vert ↓ ↑ 〉 {e}^{- i Δω {t}_{0}} ]$$

where we have assumed that a is sufficiently small that the |ee [symbol] component can be ignored. Δω is given by ω_{A,2}−ω_{A,1}−ω_{f,2}+ω_{f,1} where ω_{x,N} is the angular frequency for transition x of ion N. The time t₀ is the detection time of the photon measured relative to the center of the heralding period, i.e. t₀∈[−τ,τ].
6. Assuming that the photon detection timing electronics are sufficiently precise, the measured value of t₀ and the pre-determined value of Δω are sufficient to ascertain the quantum phase of the prepared Bell state: φ=Δωt₀. The final step in the protocol is to use this information to correct the phase of the quantum state, by performing a differential z-rotation (phase shift) of the two ground state qubits by an amount φ. Note that this phase must be determined and the correction applied within the coherence of the ground state qubits. The final prepared two qubit state is now:

$$\frac{1}{\sqrt{2}} [ \vert ↑ ↓ 〉 + \vert ↓ ↑ 〉 ]$$

### Protocol Explanation

In this section we provide further details/explanation of the protocol and identify how the protocol addresses the three main issues/limitations of conventional methods.

Low photon detection efficiency is addressed via the implementation of a single photon protocol. During heralding portions of the sequence, the dominant component in the superposition is (1−α)|↓↓ [symbol] , detection of a single photon removes this and ‘carves out’ the Bell state. However, note that there is also a contribution from the |ee [symbol] component, and ignoring this component introduces an error into the heralded quantum state resulting in a fidelity that is upper-bounded by F=1−α. Hence a needs to be small: this protocol should be used when the maximum admissible infidelity, αₘₐₓ is larger than the photon detection efficiency, n. Furthermore, note that during rephasing periods the dominant component is (1−α)|ee [symbol] which is optically bright, hence photon detection cannot be used to herald entanglement during these periods. An example of a single photon protocol with more detailed description can be found here [1].

Static optical inhomogeneity is addressed via the phase correction step in the protocol. Namely, any constant optical and spin frequency differences between the two ions are compensated by detecting the photon emission time and feeding forward to correct the resulting Bell state phase. This aspect of the protocol has been proposed in [2].

Non-static optical inhomogeneity is corrected via the dynamical decoupling aspect of this sequence. Note that this effect is only corrected if the dynamic frequency fluctuations are sufficiently slow, namely quasi-static, on the timescale of a dynamical decoupling period (2T). The sequence is constructed such that any phase accumulated during the second half of a given heralding (rephasing) period is cancelled by phase accumulated during the first half of the subsequent rephasing (heralding) period. Hence, points in the sequence with zero accumulated phase (rephasing points) are equidistantly spaced between sequential i pulses. Note also that even though the optical Ramsey coherence time doesn't constrain the total dynamical decoupling time (4 Nτ), a value of τ must be chosen that satisfies τ<T₂*, where T₂* is the optical transition Ramsey coherence time.

An added benefit of this protocol is that points of maximal heralded coherence (rephasing points) are maximally distant from any optical pulses (contained within the \tilde{π} pulses). This is particularly relevant in experimental configurations where single emitted photons are distinguished from laser excitation pulses in the time domain (instead of via frequency or polarization filtering). It ensures that finite rise/fall times of laser pulses don't prevent the detection of single photons around the region of maximal coherence.

### Generalized π Pulses

The \tilde{π} pulses implemented in the protocol of the first example need to swap population between the |↓ [symbol] and |e [symbol] levels of a given qubit. If there is a coherent optical transition connecting these levels, it can be used. However, a likelier scenario is that needs to be composed of sequential application of pulses on other transitions. For example, a π pulse on A, followed by a π pulse on f followed by another π pulse on A as shown in FIG. 2b.

The main source of infidelity in this \tilde{π} pulse is likely due to imperfect optical control of the A transition. We therefore disclose a more advanced generalised pulse (depicted in FIG. 2c) which utilises additional energy level structure in FIG. 1b to mitigate the imperfect optical transition control. It consists of an optical π pulse on the A transition followed by a dynamical decoupling sequence which is simultaneously applied to the ground and excited state microwave transitions, f and g respectively. It consists of M repetitions of a base sequence with duration 2T_{DD} and must be applied for a total duration 2MT_{DD} that is longer than the optical lifetime. Finally, a second optical pulse is applied to the A transition.

### Phase Correction

If the two qubits are located in physically separate devices, then the Bell state phase correction step can be achieved by changing the phase of subsequent (for this example, microwave) control pulses. Specifically, the definition of the X and Y phase quadratures for ground state qubit control can be rotated by angles of −φ/2 and +φ/2 for lon 1 and lon 2 respectively.

However, if the two qubits are located in the same device, it is likely that (in this example, microwave) control is global. In this case, independent control of the (e.g., microwave) driving phase for the two qubits isn't possible. As an alternative, the AC stark shift can be leveraged, whereby a single detuned optical pulse is applied to the device. Due to the optical frequency difference between the two qubits (e.g., ions), the pulse will have a different detuning from transition A₁ compared to transition A₂. Hence, the pulse will induce a different frequency shift on the ground state spin transition f₁ of qubit 1 compared to f₂ of qubit 2. While the pulse is applied, each of the qubits will accumulate a phase on the ground state transition, at a rate determined by the corresponding frequency shift. By tailoring the duration or amplitude of this detuned optical pulse, the resulting differential ground state phase accumulated between the two qubits can be controlled. This protocol is described in detail here [3].

Comparison with Traditional Entanglement Protocols

Conventional entanglement protocols that don't leverage dynamical decoupling are fundamentally limited by the optical Ramsey coherence decay time (T₂*). This is often shorter than the lifetime limit (T₂*<2T₁), where T₁ is the optical lifetime, and leads to one of two tradeoffs:
If heralding photons are accepted during the entire emission time, then the efficiency of the protocol is maximised. However, the fidelity of the resulting entangled state is limited by a factor ˜T₂*/T₁.

As an alternative, we can restrict the acceptance window during which photons are heralded to the optical coherence time (i.e. photons only accepted if the emission time t₀<T₂*) in which case the fidelity is maximised but the heralding efficiency is limited by a factor ˜T₂*/T₁.

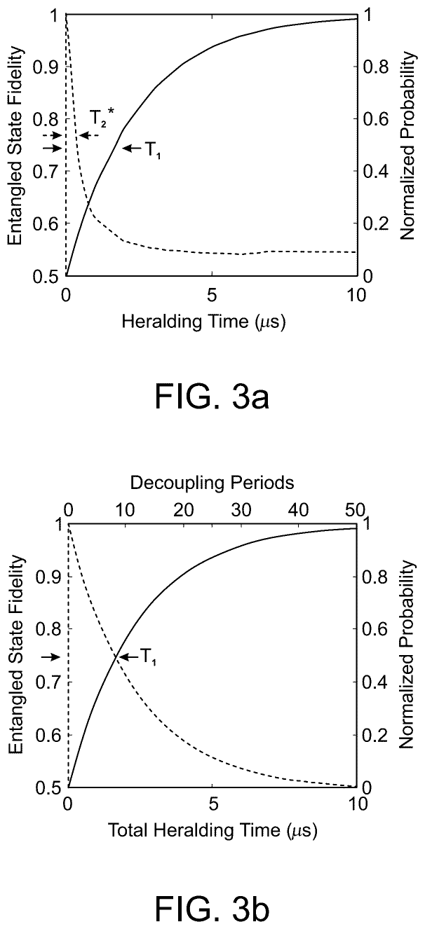

FIG. 3a demonstrates this trade-off, with simulated fidelity and efficiency both plotted against the heralding window duration. If T₂* is much less than T₁ then either the efficiency or fidelity will need to be dramatically compromised.

The corresponding simulations for the dynamical decoupling protocol (this invention) are shown in FIG. 3b. As the total heralding duration (corresponding to the number of dynamical decoupling periods) increases, the fidelity decays with a T₁ timescale. Critically, this is the same timescale as the saturation in optical efficiency. Hence, the trade-off between efficiency and fidelity isn't impacted by the ratio of T₂*/T₁ and high fidelity, high efficiency can be heralded regardless of T₂*.

Finally, the source of T₁ decay in the heralded entanglement fidelity is caused by undetected photon emissions during rephasing periods. If one of these occurs prior to a subsequently successful heralding period, then the heralded state will correspond to |↑↑ [symbol] rather than the expected Bell state, i.e. a source of infidelity. The likelihood of this occurring saturates with an exponential timescale of the optical lifetime, T₁.

### REFERENCES FOR FIRST EXAMPLE

[1] Humphreys, P. C et al. Deterministic delivery of remote entanglement on a quantum network. Nature 558, 268-273 (2018).
[2] Vittorini, G. et al. Entanglement of distinguishable quantum memories. PRA 90, 040302 (2014).
[3] Chen, S. et al. Parallel single-shot measurement and coherent control of solid-state spins below the diffraction limit. Science 370, 592-595 (2020).

### Entanglement Results Using Protocol of the First Example

a. No Feed-Forward

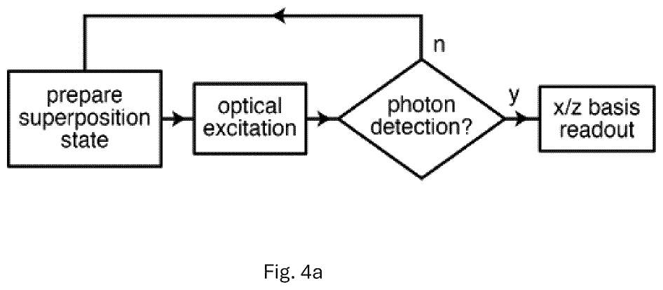

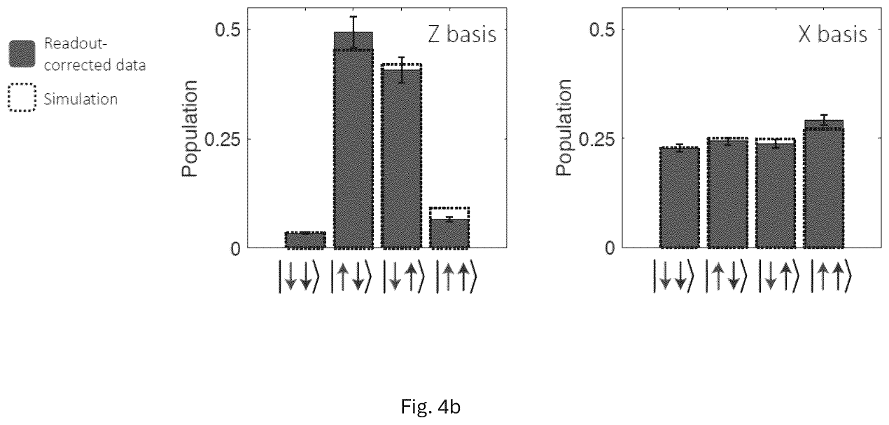

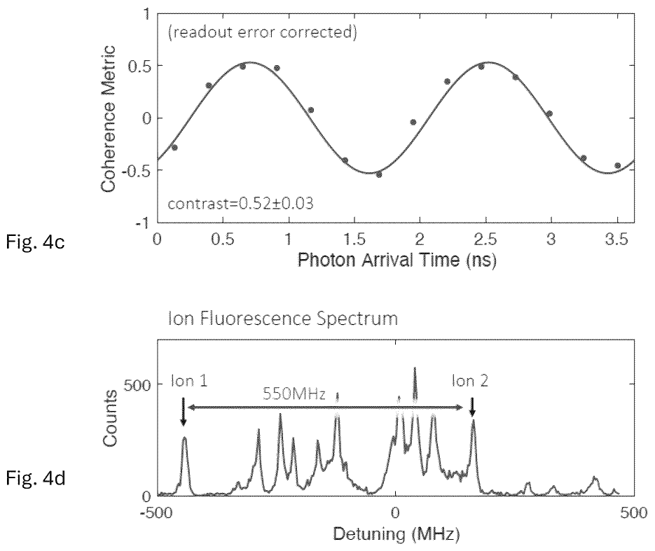

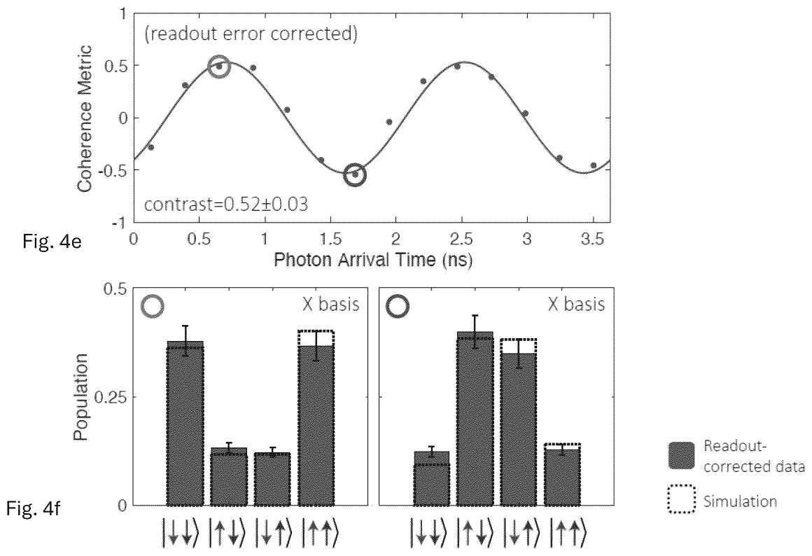

FIG. 4a is a flowchart illustrating a method of preparing an entangled state and measuring the entangled state (readout). FIG. 4b compares the measured entanglement with simulation readout using α=0.1:F<0.9. Solid/dashed are readout corrected/uncorrected. The x-basis histogram looks like a mixed state (not accounting for photon arrival time).

FIGS. 4c and 4d illustrate correlating photon Arrival with coherence. Photon emission time determines x basis Bell state:

$$\vert {Φ}^{-} 〉 cos ( \frac{Δω {t}_{0}}{2} ) + \vert {Ψ}^{-} 〉 sin ( \frac{Δω {t}_{0}}{2} )$$

The x-basis state can be correlated with to by plotting coherence metric:

$$R = {ρ}_{↓ ↓} + {ρ}_{↑ ↑} - {ρ}_{↓ ↑} - {ρ}_{↑ ↓}$$

Oscillation at Δω=550 MHz corresponds to separation in fluorescence spectrum. Note, photon arrival times histogrammed according to:

$$mod ( {t}_{0} , 4 π / Δω )$$

FIG. 4f compares the measured and simulated X-basis after corelating photon arrival at the times indicated in FIG. 4e.

b. With Feedforward and AC Stark Shift for Correcting Phase

As detailed herein, there is a need to correct the phase in the state:

$$\vert ↓ ↑ 〉 + \vert ↑ ↓ 〉 {e}^{i Δω {t}_{0}}$$

In some applications, global microwave control precludes ion-selective basis rotation. In these cases, it is possible to leverage optical inhomogeneity using differential AC Stark shift.

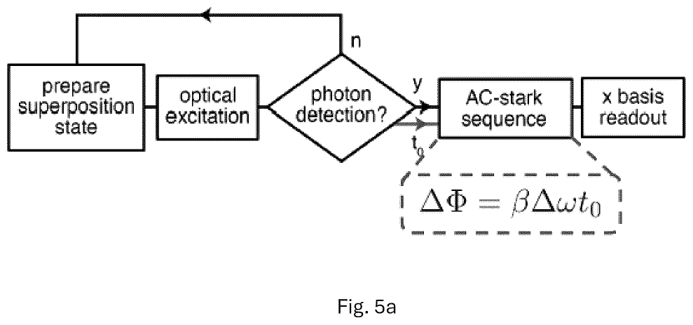

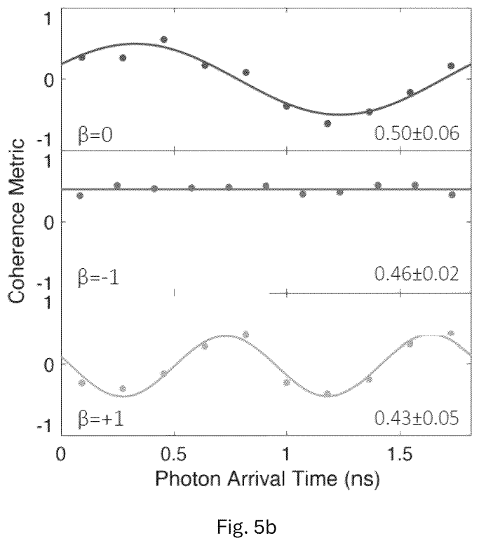

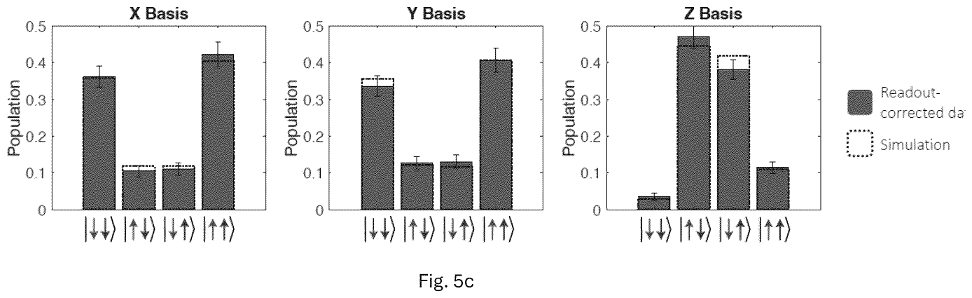

FIG. 5a illustrates a method of preparing a superposition state and performing a feedforward of the photon arrival time selecting an AC Stark Pulse sequence prior to readout. There are three distinct cases (coherence metric illustrated in FIG. 5b):

$$β = 0 : no feed - forward .$$

$$β = - 1 feedforward compensates stochastic phase .$$

$$β = + 1 feedforward compensates stochastic phase .$$

FIG. 5c illustrates the measured and simulated readout when feedforwarding the photon arrival time and selecting the AC Stark Pulse prior to readout. The readout corrected (uncorrected) entangled state fidelity is F=0.69±0.03 (0.62±0.02) and the Bell state generation rate is ˜0.5 Hz.

The results indicate successful demonstration of heralding of entanglement between single rare earth ions, cavity-coupled quantum nodes with all necessary requirements for a quantum repeater, measurement-based frequency erasure spans inhomogeneous optical frequency distribution, and that dynamical decoupling overcomes limit imposed by T₂*

c. Comparison to Other Systems

| | Entangled | | | |
|---|---|---|---|---|
| | State | Entanglement | | |
| | Fidelity | Rate | | Spin Coherence |
| REIS | 0.69 | 0.5 | Hz | 16 ms electronic |
| | | | | (760 μs nuclear) |
| NV | 0.8^{[1]} | 10 | Hz^{[1]} | ~1 ^{[2]} electronic |
| Centers | | | | (120 s nuclear ^{[3]}) |
| SiV | 0.71^{[4]} | 0.9 | Hz^{[4]} | 1-10 ms electronic ^{[5]} |
| Centers | | | | (2 s nuclear ^{[6]}) |
| Quantum | 0.62^{[7]} | 7.3 | kHz^{[7]} | ~3 μs^{[8]} |
| Dots | | | | |
| Trapped | 0.85^{[9]} | 0.05 | Hz^{[9]} | ~100 μs^{[9]} |
| Atoms | | | | (extended to 20 ms^{[10]}) |
| Trapped | 0.94^{[11]} | 200 | Hz^{[11]} | ~2 ms^{[11]} |

| | |
|---|---|
| Ions | (dual species, 10 s ^{[12]}) |

^{[1]}Pompili M., et. al. Science, 372, 259 (2021).
^{[2]} Bar-Gill N., et al. Nat. Comms, 1743 (2013).
^{[3]} Bartling H. P., et al. PRX, 12, 011048 (2022).
^{[4]}Levonian D. S., et al. PRL, 128, 213602 (2022).
^{[5]} Nguyen C. T., et al. PRB, 100, 165428 (2019).
^{[6]} Stas P.-J., et al. Science, 378, 557 (2022).
^{[7]}Stockill R., et al. PRL, 119, 010503 (2017).
^{[8]}Stockill R., et al. Nat. Comms, 12745 (2016).
^{[9]}Ritter S., et al. Nature, 484, 195 (2012).
^{[10]}Langenfeld S., et al. PRL, 126, 230506 (2021).
^{[11]}Stephenson L. J., et al. PRL, 124, 110501 (2020).
^{[12]} Drmota P, et al. arXiv: 2210.11447 (2022).

### Error Budget

Simulated fidelity (all errors included): 0.70
Simulated fidelity with all errors removed: 1.00

| | Fidelity if Error | Fidelity if only Error |
|---|---|---|
| | Removed | Present |
| Dark count rate, | 0.81 | 0.85 |
| initialisation fidelity | | |
| and choice of alpha | | |
| Combined optical and | 0.80 | 0.86 |
| spin decoherence | | |
| Control fidelities | 0.72 | 0.96 |
| Decoupling protocol | 0.72 | 0.92 |
| (T₁ limit) | | |

### Second Example Protocol

This example describes an additional pulse sequence which can be used to herald entangled states between remote, optically-addressed qubits (i.e. qubits without local interactions). As with the protocol described in the first example, this sequence simultaneously addresses three major imperfections found in quantum network nodes:
1. Low photon collection or detection efficiency.
2. Static optical inhomogeneity.
3. Dynamic optical inhomogeneity.

In contrast to the first example pulse sequence, this protocol provides a more robust approach to addressing dynamic inhomogeneity (Point 3) which is also easier to implement experimentally.

Also presented are experimental results for three different entanglement protocols using the ¹⁷¹Yb:YVO₄ platform which was described [4] and patent [5]. The three protocols considered are:
1. A basic ‘Ramsey protocol’ which is the conventional approach used in our field.
2. A ‘pre-compensated phase accumulation protocol’ which is the N=1 case of the protocol described in the original disclosure.
3. A ‘dynamic rephasing protocol’ which is described in the first section of this addendum.

The protocol is also implemented with the qubit having the energy level structure in FIG. 1.

### Protocol Outline

The protocol proceeds as follows:
1. The two qubits are each initialised into a specific ground state level, for the sake of example we will assume level |↓ [symbol] .
2. A (e.g., microwave) pulse is applied to the ground state transition, f, thereby preparing an imbalanced superposition of the two levels |↓ [symbol] and |↑ [symbol] . Specifically, each qubit is prepared in the state:

$$\sqrt{1 - α} \vert ↓ 〉 + \sqrt{α} \vert ↑ 〉$$

such that the two qubit state is given by:

$$( 1 - α ) \vert ↓ ↓ 〉 + \sqrt{α ( 1 - α )} [ \vert ↑ ↓ 〉 + \vert ↓ ↑ 〉 ] + α \vert ↑ ↑ 〉$$

3. Each of the two qubits is optically excited (i.e. resonant optical π pulses are simultaneously applied to transition A₁ of qubit 1 and A₂ of qubit 2). This yields the state:

$$( 1 - α ) \vert ↓ ↓ 〉 + \sqrt{α ( 1 - α )} [ \vert e ↓ 〉 + \vert ↓ e 〉 ] + α \vert ee 〉$$

4. Subsequently, during a measurement window of duration τ, detection of a single photon heralds the preparation of an entangled state. Specifically, the photon emission occurs randomly (according to an exponential distribution), with corresponding stochastic measurement time t₀ such that t₀∈[0,τ]. The two-qubit state at the end of the heralding period is given by:

$$\frac{1}{\sqrt{2}} [ \vert ↑ ↓ 〉 + \vert ↓ ↑ 〉 {e}^{- i ( {ω}_{A , 2} - {ω}_{A , 1} ) {t}_{0} - i ( {ω}_{f , 2} - {ω}_{f , 1} ) τ} ]$$

where ω_{x,N} is the angular frequency for transition x of ion N. We have assumed that a is sufficiently small that the |↑↑ [symbol] component can be ignored.
5. Next, both optical and spin coherences are rephased as follows. Firstly, two π pulses are simultaneously applied to the f transitions of the two ions and the spin coherence is rephased for a duration (τ−t₀). Then, π pulse are applied to the A transitions of the two ions, thereby transferring |↑ [symbol] to |e [symbol] . After waiting for a duration t₀, a second pair of π pulses are applied to the A transitions to transfer |e [symbol] back to |↑ [symbol] . This acts to rephase optical coherence. The two-qubit state after this period is given by:

$$\frac{1}{\sqrt{2}} [ \vert ↓ ↑ 〉 {e}^{- i ( {\tilde{ω}}_{f , 2} - {\tilde{ω}}_{f , 1} ) 2 τ} + \vert ↑ ↓ 〉 {e}^{- i ( {\tilde{ω}}_{A , 2} - {\tilde{ω}}_{A , 1} ) {t}_{0}} ]$$

where \tilde{ω}_{x,N} is the driving frequency for transition x of ion N. Now we transfer into a rotating frame for each of the two ions' ground state qubit transitions (rotating at \tilde{ω}_{f,1} and \tilde{ω}_{f,2} for ions 1 and 2 respectively), defining the zero-phase point for these two frames to occur at the start of the pulse sequence (t=0) we find that the two-qubit state can be written as:

$$\frac{1}{\sqrt{2}} [ \vert ↓ ↑ 〉 + \vert ↑ ↓ 〉 {e}^{- i ( {\tilde{ω}}_{A , 2} - {\tilde{ω}}_{A , 1} ) {t}_{0}} ]$$

6. Finally, assuming that the photon detection timing electronics are sufficiently precise, the measured value of to and the pre-determined value of Δ\tilde{ω}=\tilde{ω}_{A,2}−\tilde{ω}_{A,1} are sufficient to ascertain the quantum phase of the prepared Bell state: φ=Δ\tilde{ω}t₀. The final step in the protocol is to use this information to correct the phase of the quantum state, by performing a differential z-rotation (phase shift) of the two ground state qubits by an amount φ. Note that this phase must be determined, and the correction applied within the coherence of the ground state qubits. The final prepared two qubit state is now:

$$\frac{1}{\sqrt{2}} [ \text{\textbar ↓↑} 〉 + \vert \text{↓↑} 〉 ]$$

Low photon detection efficiency is addressed via the implementation of a single photon protocol. During the heralding portion of the sequence, the dominant component in the superposition is (1−α)|↓↓ [symbol] , detection of a single photon removes this and ‘carves out’ the Bell state. However, note that there is also a contribution from the |ee [symbol] component, and by ignoring it we are introducing an error into the heralded quantum state resulting in a fidelity that is upper-bounded by F=1−α. Hence a needs to be small: this protocol should be used when the maximum admissible infidelity, αₘₐₓ is larger than the photon detection efficiency, η [1].

Non-static optical inhomogeneity is corrected in Step 5. It is noted that the delay times associated with rephasing periods in this step depend on the stochastic photon emission time (t₀), and hence need to be varied/adjusted in real-time. We term this approach ‘dynamic rephasing’. It is also noted that this protocol only works if the dynamic frequency fluctuations are sufficiently slow, namely quasi-static, on the timescale of the pulse sequence.

After dynamic rephasing, the heralded Bell state will still have a stochastic phase given by φ=Δ\tilde{ω}t₀. Critically, this phase depends on the optical drive frequency difference rather than the (varying) ion frequency difference. By detecting the photon emission time and feeding forward to correct this phase, a deterministic Bell state can be obtained. This aspect of the protocol has been proposed in [2]. Since the frequencies of the two excitations lasers are chosen to match the time-averaged optical transition frequencies of the two ions, this aspect of the sequence compensates for static inhomogeneity.

Besides the fidelity limitation introduced by the choice of a, there are two additional sources of infidelity that occur during dynamic rephasing. Firstly, any undetected spontaneous emission during the optical rephasing period (i.e. between the two sets of optical pulses in Step 5) will lead to a reduction in entangled state coherence. Secondly, any pure dephasing of the optical transition during both the heralding and optical rephasing periods. Combined, these two effects lead to an entangled state coherence which decays according to C∝e^{-t}^{₀}^{(2γ}^{_{d}}^{+1/T}^{₁}⁾. Where Ya is the pure dephasing rate and T₁ is the optical lifetime, these are assumed equal for the two ions. Hence, lower fidelity entangled states will be heralded for later photon detection times. Assuming that pure dephasing is negligible (γ_{d}˜0), the entangled state fidelity will now be limited by the optical lifetime rather than the optical Ramsey coherence time, in stark contrast to conventional entanglement sequences. It is noted that this lifetime limitation isn't fundamental: optical rephasing could be performed using a transition with longer optical lifetime, for instance, if the A transition were selectively Purcell enhanced using a high Q cavity, the un-enhanced E transition could be used for rephasing.

### Experimental Results for the Second Example Protocol

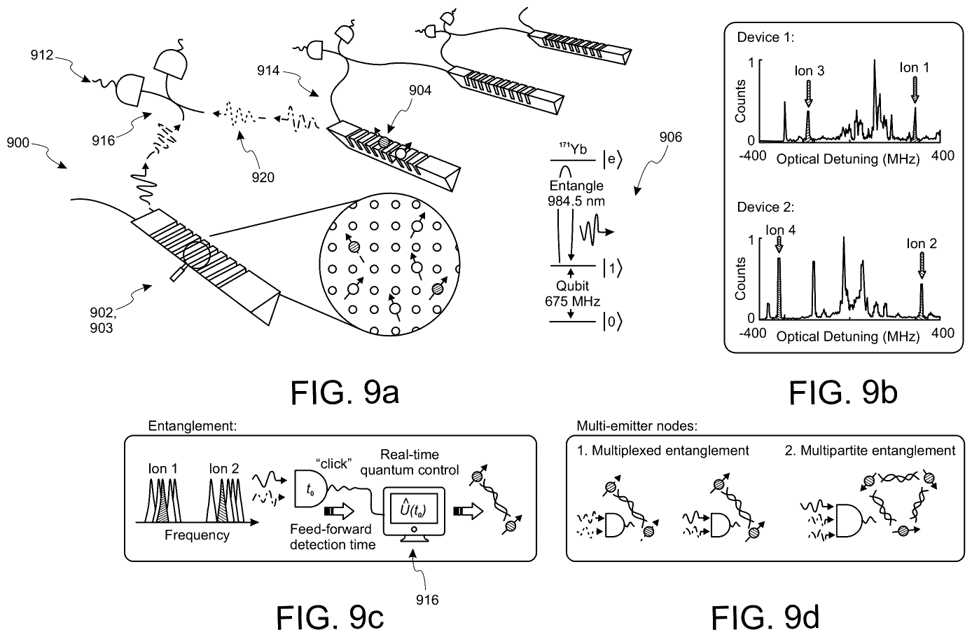

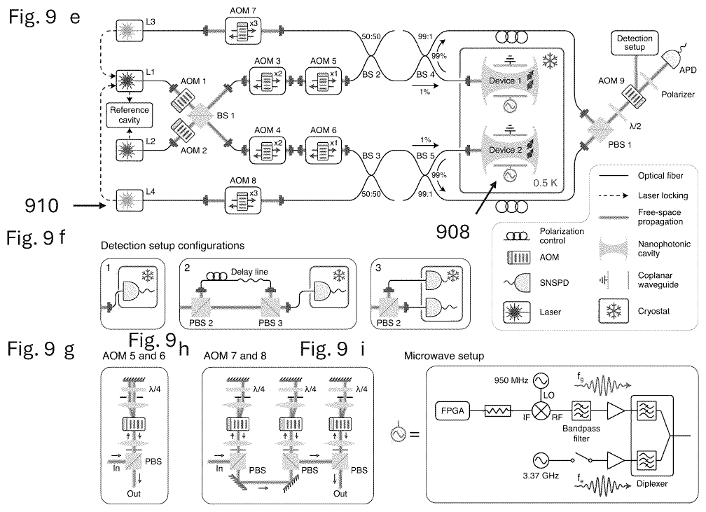

The experimental results were obtained using the system of FIG. 9.

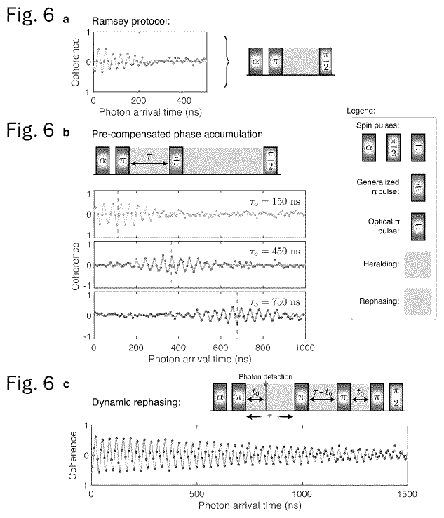

FIG. 6a shows the entangled state coherence as a function of photon measurement time for a conventional (Ramsey) entanglement protocol depicted in the inset. The measurement is fitted to a decaying oscillation with a Gaussian envelope with form:

$$C ( {t}_{0} ) = A cos ( Δ ω {t}_{0} + ϕ ) {e}^{- \frac{{t}_{0}^{2}}{{T}^{2}}}$$

The oscillation frequency of Δω=30.8±0.2 MHz matches the two ions' optical frequency difference and the Gaussian decay timescale of T=160±40 ns matches well with the predicted value of 180±9 ns for two ions experiencing uncorrelated optical spectral diffusion. Note that the fraction of coherent photonic emission is limited by the optical Ramsey coherence time.

The protocol in the first example (where we set the number of dynamical decoupling periods, N=1) involves pre-compensated phase accumulation for a duration τ prior to entanglement heralding. FIG. 6b shows the resulting entangled state coherence for three different values of τ=150, 450, 750 ns. The fraction of optical emission which yields a coherent entangled state is still limited by the optical frequency stability (i.e. the optical Ramsey coherence time), however, the photon emission time corresponding to maximal coherence can now be controlled and matches τ. This enables us to herald with a window size that is twice as large compared to FIG. 6a, and also avoid regions of the photon emission which overlap with laser reflections. In principle, one can increase the fraction of photonic emission used for heralding by increasing N, as described in the first example.

The updated protocol involves rephasing the optical coherence for a duration t₀ after heralding an entangled state as proposed in this second example. Experimental results are shown in FIG. 6c. The fraction of photonic emission which heralds a coherent entangled state is considerably increased. The experimental results are fitted to:

$$C ( {t}_{0} ) = A cos ( Δ \tilde{ω} {t}_{0} + ϕ ) {e}^{- \frac{{t}_{0}}{T}}$$

where Δ\tilde{ω} is now fixed to the laser frequency difference, A=0.62±0.02 and τ=1070±50 ns are extracted from the fit. For two ions with optical lifetimes

$${T}_{1}^{( 1 )} and {T}_{1}^{( 2 )}$$

and pure optical dephasing rates of

$${γ}_{d}^{( 1 )} and {γ}_{d}^{( 2 )}$$

we would expect the exponential decay timescale to satisfy

$$\frac{1}{T} = {γ}_{d}^{( 1 )} + {γ}_{d}^{( 2 )} + \frac{1}{2 {T}_{1}^{( 1 )}} + \frac{1}{2 {T}_{1}^{( 2 )}}$$

which is estimated to be 970±30 ns. This simple model matches reasonably well with the experimental result. Crucially, we can see that the coherence decay of the entangled state is now limited by the ions' optical lifetimes, even though the transitions are not Fourier limited. To our knowledge, this has not been demonstrated in any other entanglement experiments.

Note that the results in FIGS. 6b and 6c correspond to performing Steps 1-5 in each protocol (i.e. they do not correct for the Bell state phase associated with the static ion frequency difference and stochastic photon emission time). To ensure deterministic preparation of a specific Bell state, we need to correct this phase in each experiment. For the dynamic rephasing protocol, this phase is given by Δω₀t₀ where Δω₀ is the laser drive frequency difference. Without this correction, if averaged over multiple experiment repetitions, the density matrix will be identity in the single excitation subspace

$$ρ = \frac{1}{2} [ \vert \text{↓↑} 〉 〈 \text{↓↑} \vert + \vert \text{↓↑} 〉 〈 \text{↓↑} \vert ] ,$$

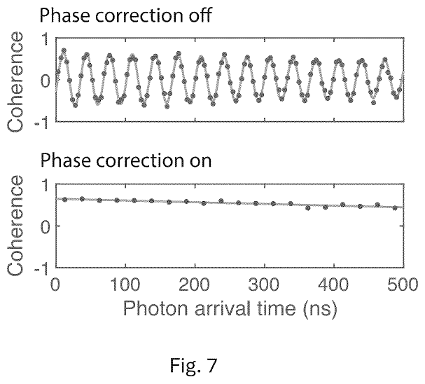

this is a classically correlated state, not a quantum entangled state. This is depicted in the upper panel of FIG. 7 where we see the coherence oscillating at 30.8 MHz, if one ignored the photon arrival time the resulting average coherence would be 0. Correcting this stochastic phase for ions in two separate devices is performed by changing the phase of the X and Y spin driving quadratures for one of the two devices. This performs a differential z-rotation thereby applying a phase shift to the resulting Bell state measurements. The z-rotation angle is chosen to precisely counteract the stochastic phase i.e. −Δω₀t₀. When we repeat the experiment with this phase correction (FIG. 7, lower panel), we see that the fast oscillation has indeed been counteracted and the coherence will average to a non-zero value.

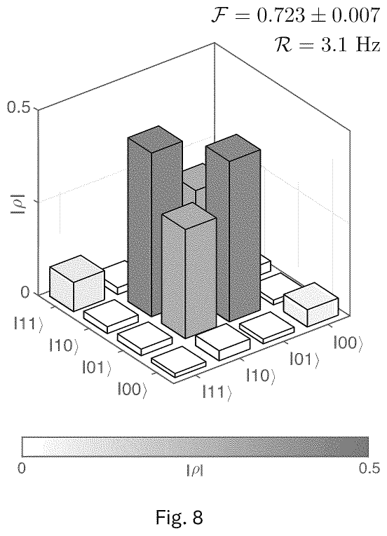

The entangled state in all 9 possible 2-qubit Pauli bases was measured and shown in FIG. 8. Using these results we performed maximum likelihood quantum state tomography to extract a density matrix. The resulting fidelity is F=0.723±0.007 with the error estimated via bootstrapping. This result is obtained with a 500 ns acceptance window size leading to an entanglement rate of 3.1 Hz.

### REFERENCES FOR SECOND EXAMPLE

[1] Humphreys, P. C et al. Deterministic delivery of remote entanglement on a quantum network. Nature 558, 268-273 (2018).
[2] Vittorini, G. et al. Entanglement of distinguishable quantum memories. PRA 90, 040302 (2014).
[3] Chen, S. et al. Parallel single-shot measurement and coherent control of solid-state spins below the diffraction limit. Science 370, 592-595 (2020).
[4] Kindem, J. M. et al. Control and single-shot readout of an ion embedded in a nanophotonic cavity. Nature 580, 201-204 (2020).
[5] U.S. Pat. No. 11,438,076B2: “Optical quantum networks with rare-earth ions”

### Third Example Remote Entanglement Distribution in Quantum Network Nodes

FIGS. 9a and 9b illustrates a quantum networking platform consisting of two separate nanophotonic cavities (labelled Device 1 and Device 2), each fabricated from an (YVO₄) crystal which hosts single ¹⁷¹Yb³⁺ ions. These ions fulfil many requirements for quantum network nodes including: a ground state spin qubit (hyperfine states |0 [symbol] and |1 [symbol] separated by 2π×675 MHz) [26, 42]; a coherent, cycling optical transition (|1 [symbol] ↔|e [symbol] at 984.5 nm) verified via Hong-Ou-Mandel interferometry in the appendix (see Supplementary Information Section III and Extended Data FIG. 1 in the appendix, also priority application U.S. Provisional Application No. 63/705,663 filed Oct. 10, 2024); and an auxiliary quantum memory, implemented via local nuclei or [43].

There are approximately twenty ¹⁷¹Yb³⁺ ions in each cavity (FIG. 9b) with a static optical inhomogeneous distribution of ≈2π×200 MHz. In Device 1, we use two of the 7 spectrally resolved ions (Ion 1 and Ion 3), each with ≈2 μs Purcell-enhanced lifetime, while in Device 2, we use two of the 8 spectrally resolved ions (Ion 2 and Ion 4) with ≈1 μs lifetime (see Supplementary Information FIGS. S1 and S2 for details in the appendix). Each ion has a long-term integrated optical linewidth of ≈2π×1 MHz (defined as the standard deviation of the optical frequency distribution) which is roughly ten times broader than the lifetime limit. However, using optical echo measurements we obtain near lifetime-limited decays, confirming that the linewidth is dominated by slow spectral wandering. We use a novel delayed echo measurement scheme to extract an optical spectral diffusion correlation timescale of 1.42+/−0.04 ms (Extended Data FIG. 2 and Supplementary Information Section IV of the appendix). We note that lifetime limited emission has been observed in various rare-earth platforms [26, 44, 45].

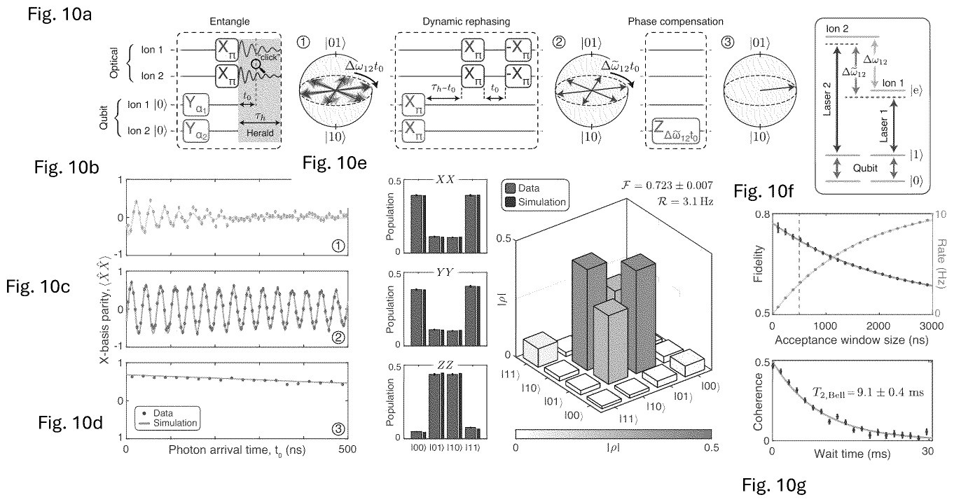

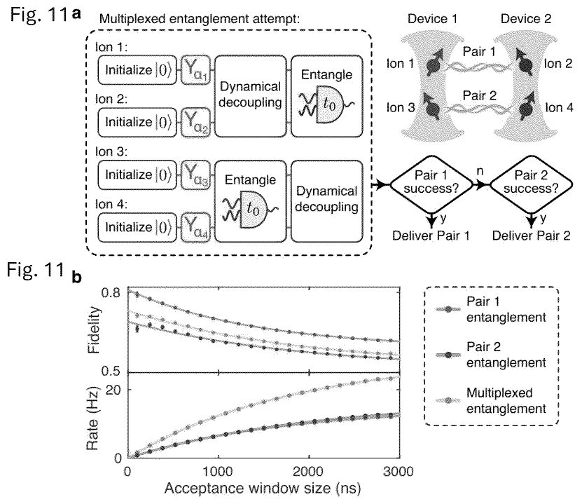

The single-photon heralding protocol to efficiently and robustly entangle distinguishable ions (depicted in FIG. 10a and elaborated in the Extended data FIG. 4 in the appendix).

The procedure started by initializing both ions in |0 [symbol] . Subsequently, the optical phase drift between the two device paths was measured via heterodyne interferometry and compensated by a laser phase rotation (See Methods Section B and Extended Data FIG. 5 in the Appendix). We applied a microwave pulse to each qubit in parallel, preparing an initial state, |ωᵢₙᵢₜ [symbol] , consisting of a weak superposition with small probability, ₁₄₅αᵢ, in the |1 [symbol] state of Ion i:

$$\vert {ψ}_{i n i t} 〉 = ( \sqrt{1 - {α}_{1}} \vert 0 〉 + \sqrt{{α}_{1}} \vert 1 〉 ) ⊗ ( \sqrt{1 - {α}_{2}} \vert 0 〉 + \sqrt{{α}_{2}} \vert 1 〉 )$$

Subsequently, each ion was optically excited with a resonant I pulse, transferring population from |1 [symbol] to |e [symbol] . An entangled state is heralded when a single photon is detected from spontaneous emission, which occurs at random time t₀. This eliminates the optically dark contribution, |00 [symbol] ; furthermore, using small αᵢ mitigates the likelihood of double photon emission, associated with the |11 [symbol] state. The probabilities α₁ and α₂ are chosen to maximize the entangled state fidelity with values of 0.062 and 0.078 respectively (See Methods Section C in the appendix).

Specifically, the heralded entangled state is of the following form:

$$\vert ψ ( {t}_{0} ) 〉 = a ( {t}_{0} ) \vert 10 〉 + b ( {t}_{0} ) \vert 01 〉 {e}^{- i ϕ ( {t}_{0} )} \qquad ( 1 )$$

with the random, t₀-dependent phase φ(t₀)=Δω₁₂×t₀, where Δω12=@2−ω1 is the optical frequency difference between the two ions [47]. Here, a(t0) and b(t0) are real coefficients defined in Methods Section C of the appendix. For simplicity in the subsequent protocol description, we will consider a pure state with a(t0)=b(t0)=1/\sqrt{2} in equation (1).

Experimentally, we characterized entangled state coherence by measuring a parity oscillation of |ω(t0) [symbol] correlated with the stochastic photon detection time, to (FIG. 10b, Panel ∘1). We combatted both the decay and oscillatory behaviour of the coherence with the two subsequent stages of this protocol, thereby boosting the entangled state fidelity and generation rate. In the first stage, we applied a dynamic rephasing sequence to cancel the effect of quasistatic optical and qubit frequency variations. Within the heralding window of duration τh=2.9 μs, the two ions spent a duration t0 in a superposition of |0 [symbol] and |e [symbol] undergoing optical dephasing. After spontaneous emission, they spent the remaining duration, τh−t0, in a superposition of |0 [symbol] and |1 [symbol] undergoing qubit dephasing (Supplementary Information Section VI of the appendix). The amount of dephasing changed from shot to shot due to the variable optical and qubit transition frequencies and the random photon emission time, t0. In the dynamic rephasing protocol the durations of subsequent evolution periods were adjusted in real-time based on the previously measured photon emission time. Specifically, after the heralding window, we applied π pulses to each qubit and wait for 201 a duration τh−t0, thereby rephasing the qubit coherence. Then, we transferred population from |1 [symbol] to |e [symbol] with optical π pulses applied to both ions, wait for a duration t0 to rephase the optical coherence, and coherently transfer the population back to |1 [symbol] with a second pair of optical π pulses. This requires the optical frequency to remain stable between entanglement heralding and dynamic rephasing. Given the long optical frequency correlation timescale (τc=1.42+/−0.04 ms) this holds true, even for long-range entanglement links (see Supplementary Information Section VI in the appendix).

Using this dynamic rephasing sequence, the parity oscillations persist to much longer photon detection times verifying that the effect of optical frequency fluctuations has been mitigated (FIG. 10c, Panel (2). In contrast to the case where the parity oscillation frequency was determined by the fluctuating relative difference in transition frequencies between Ions 1 and 2, the dynamic rephasing protocol leads to a frequency that is stably set by the relative difference in driving laser frequencies, denoted Δ\tilde{ω}₁₂. At later photon detection times (Extended Data FIG. 6 in the appendix), we observed an exponential decay in contrast. This occurs due to the optical rephasing step, where ions stay in the excited state for a duration t₀, and any undetected emission would destroy the entangled state's coherence. The likelihood of emission increases with later photon arrival times, governed by the ions' optical lifetimes (Supplementary Information Section VI in the appendix).

While Δ\tilde{ω}₁₂ is static, the residual entangled state phase, φ(t₀)=Δ\tilde{ω}₁₂t₀, is still random due to the stochastic nature of t₀, requiring real-time feedforward phase compensation [41]. To this end, the second stage of our protocol counteracts this parity oscillation by applying a Z-rotation to Ion 2's qubit (i.e. between |0 [symbol] and |1 [symbol] ) by an angle Φ=φ(t₀). Panel (3) in FIG. 10b shows that the stochastic phase is successfully compensated, indicating that a deterministic, phase-stabilized Bell state, |ψ⁺ [symbol] , is heralded regardless of photon detection time.

The entangled state was verified by measuring populations in nine cardinal two-qubit Pauli bases along the X-, Y- and Z-axes and performing maximum likelihood quantum state tomography to reconstruct the density matrix, \hat{ρ} [48]. The entangled state fidelity, [symbol] , was determined by the overlap between \hat{ρ} and the target Bell state, |ψ⁺ [symbol] , i.e., [symbol] = [symbol] ψ⁺|\hat{ρ}|ψ⁺ [symbol] . The XX, YY and ZZ populations, and absolute density matrix values, all obtained with a 500 ns acceptance window (i.e. only accepting a photon if 0<t₀<500 ns) are plotted in FIG. 9c. All results presented in here have been corrected for readout infidelity; for more detail including raw measurement results and complex-valued density matrices see Supplementary Information Section XVI in the appendix. The resulting entangled state fidelity is F=0.723±0.007 with a heralding rate of [symbol] =3.1 Hz. Simulation results obtained from an ab-initio model with only one free parameter (a slight correction to Ion l's photon collection efficiency) predict a fidelity of [symbol] ₛᵢₘ=0.729±0.004, showing agreement within standard error (Supplementary Information Section VIII in the appendix). There is an anticorrelation between the fidelity and heralding rate with photon acceptance window size; values range from [symbol] =0.758±0.016 and [symbol] =0.73 Hz to [symbol] =0.588±0.004 and [symbol] =9.4 Hz, respectively, as the window size is increased from 100 ns to 2900 ns (FIG. 10f). Finally, we probed the entangled state storage time of the Bell state by applying an XY-8 dynamical decoupling sequence of varying duration to both qubits, yielding a 1/e decoherence time of T_{2, Bell}=9.1±0.4 ms (FIG. 10g) limited by the spin coherence of the individual qubits.

Our simulation identifies three main error sources limiting entangled state fidelities, each contributing roughly equally (Extended Data FIG. 7a in the appendix); we propose mitigation strategies in the advantages and improvements section. Firstly, photon emission from weakly coupled ions (noise counts) cause heralding events that are uncorrelated with the qubit states of Ions 1 and 2, hence primarily heralding the |00 [symbol] state. Secondly, optical gate errors originating from spontaneous emission during the optical π pulses used for dynamic rephasing. Finally, the lifetime-limited decay in entangled state coherence (Extended Data FIG. 6 in the appendix) leads to reduced fidelity for photon detection events occurring later in the heralding window. See Supplementary Information Section VIII in the appendix for more details.

The entanglement rate is determined by the product of the experiment repetition rate, 12.3 kHz, and the success probability, (2.83±0.02)×10⁻⁴ as summarized in Extended Data FIG. 7b and Supplementary Information Sections IX in the appendix. The repetition rate is limited by the ion initialization time which occupies 70% of the duration for 310 each attempt. In the next section we will demonstrate how entanglement multiplexing can be used to increase this rate.

We note that the qubit readout scheme, which is designed to mitigate against photon loss, also post-selects 312 experimental outcomes where both ions occupy the qubit 313 manifold, |0 [symbol] and |1 [symbol] . Hence, erroneous occupation of 314 auxiliary ground state spin levels would lead to a slight over-estimate of the entangled state fidelity (by a factor of ≤1.06 as detailed in Supplementary Information Section X of the appendix). To address this, we implemented a two photon entanglement protocol [49] where occupation of auxiliary states is carved out at the heralding stage, 2 leading to an unconditional (i.e. non-post-selected) fidelity of [symbol] =0.81±0.02, albeit with a reduced rate of ₃₀₄ [symbol] =0.049 Hz (see Supplementary Information Section XI and Extended Data FIG. 8). By avoiding weak superposition states, this protocol also eliminates infidelity from the |11 [symbol] contribution, while the higher bright-state population reduces the relative impact of noise counts. Additionally, the protocol is robust against optical path phase differences, removing the need for active phase stabilization and associated errors.

We also extended this two-photon entanglement scheme to probabilistically teleport quantum states between the ₄ two remote network nodes, from Ion 2 to Ion 1, as detailed 5 in Supplementary Information Section XII. We achieve ₆ an average state transfer fidelity of 0.834±0.011 which 7 exceeds the classical bound of ⅔.\

### Multiplexing Example

Next, we demonstrated how multiplexing can boost quantum communication rates between two nodes by parallelizing the limiting step of an entanglement protocol across multiple remote ion pairs. For long-distance networking, this will remove bottlenecks associated with propagation time between nodes [32,33]. In our shortrange network, multiplexed entanglement will mitigate the rate limitation imposed by ion initialization time.

For this measurement, we used four optically distinguishable qubits in a pairwise configuration: Pair 1 consists of Ions 1 and 2 that were studied previously. Pair 2 consists of Ions 3 and 4, separated by ≈2π×104 MHz (FIG. 11a). We initialized all four ions in parallel, then, we perform consecutive entanglement attempts on Pair 2, and then Pair 1 using the protocol described in FIG. 10. If a heralding photon was detected during either attempt, the experiment proceeded exclusively with the corresponding ion pair. Specifically, we performed dynamic rephasing and phase compensation to prepare a deterministic entangled state, followed by two-qubit parity measurements in the X, Y or Z bases to characterize the quantum state fidelity. Note that microwave pulses were globally applied to qubits within the same device; thus, driving frequencies are selected to be intermediate between co-located qubits.

FIG. 11b compares the entanglement rates and fidelities obtained using this multiplexed protocol with independent (non-multiplexed) measurements that exclusively entangle either Pair 1 or Pair 2 and operate with resonant qubit pulses. The multiplexed rate and fidelity range from [symbol] ₘᵤₗₜ=0.714±0.008 and [symbol] ₘᵤₗₜ=1.6 Hz to [symbol] ₘᵤₗₜ=0.571±0.002 and [symbol] ₘᵤₗₜ=23 Hz, as the photon acceptance window is increased from 100 ns to 2900 ns. Across this range, the multiplexed protocol boosts the entanglement rate by a factor of ≈1.9. Based on our rate analysis, this exceeds the theoretical prediction of 1.7 and can be explained by the off-resonant nature of dynamical decoupling pulses applied to Pair 1 qubits prior to entanglement heralding. This leads to larger probabilities of |1 [symbol] state occupation, α₁ and α₂, and an increased entanglement rate, albeit at the expense of reduced fidelity (see Supplementary Information Section XIII in the appendix for more details).

With a 500 ns photon acceptance window, we measured a multiplexed fidelity of [symbol] ₘᵤₗₜ=0.682±0.004, which is composed of

$${mult}_{( 1 )}^{} = 0.7 \pm 0.005 and {mult}_{( 2 )}^{} = 0.668 \pm 0.006$$

for Pair 1 and Pair 2 Bell states, respectively. These compare to independently measured fidelities of [symbol] ₁=0.745±0.006 for Pair 1 and [symbol] ₂=0.656±0.007 for Pair 2. In Supplementary Information Section XIII of the appendix we analyzed the entanglement fidelity reduction for Pair 1 states in the multiplexed experiment and find that it mostly arises from the off-resonant qubit pulses. We also confirmed negligible cross-talk between ions in the same device, with optical excitation and spontaneous emission not affecting other qubits. More detail on this protocol and results can be found in Supplementary Information Section XIII and Extended Data FIG. 9 of the appendix.

### Tripartite W State Generation

Finally, we demonstrated the versatility of our multiqubit quantum network nodes and the scalability of our 30 entanglement protocol by preparing distributed multipartite entangled states. Specifically, our single-photon entanglement protocol can be naturally extended to herald W states on three optically distinguishable qubits (Ions 1, 2 and 3). These are an important class of entangled 5 state with numerous quantum networking applications, 6 such as anonymous information exchange and secret voting [35]; they can also be purified and distributed over long distances using quantum repeater protocols [50].

To generate these states, each qubit started in a weak superposition, thereby suppressing contributions with more 1 than one spin excitation in the qubit manifold (e.g. |110 [symbol] and |111 [symbol] ). Subsequently, all three Ions were resonantly 3 optically excited and a single photon detection carves out the optically dark state, |000 [symbol] . Neglecting contributions with multiple spin excitations as detailed in Methods Section E of the appendix, this leads to a heralded W-state:

$$\vert ψ ( {t}_{0} ) 〉 = \frac{1}{\sqrt{3}} ( \vert 100 〉 + \vert 010 〉 {e}^{- i Δ {ω}_{12} {t}_{0}} + \vert 001 〉 {e}^{- i Δ {ω}_{13} {t}_{0}} )$$

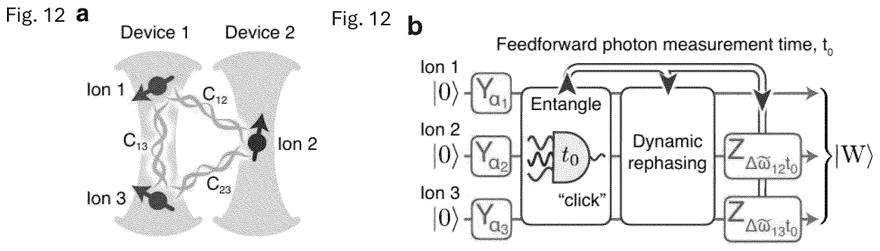

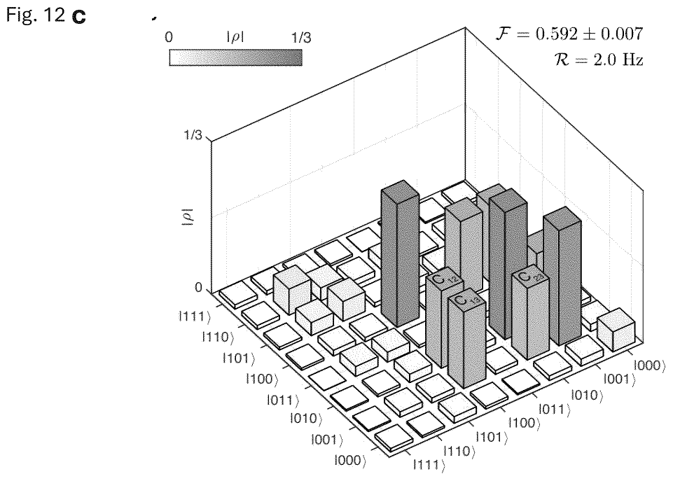

(FIGS. 12 a and 12 b). Here, t₀ is the photon detection time and Δωᵢⱼ is the fluctuating optical frequency difference between ions i and j.

We dynamically rephased optical and qubit decoherence to counteract these fluctuations, leading to:

$$\vert ψ ( {t}_{0} ) 〉 = 1 / \sqrt{3} ( \vert 100 〉 + \vert 010 〉 {e}^{- i Δ {\tilde{ω}}_{12} {t}_{0}} + \vert 001 〉 {e}^{- i Δ {\tilde{ω}}_{13} {t}_{0}} )$$

Now, there are two residual stochastic inter-qubit quantum phases that need to be compensated: Δ\tilde{ω}₁₂t₀ and Δ\tilde{ω}₁₃t₀, where Δ\tilde{ω}ᵢⱼ is the static frequency difference between lasers used to drive Ions i and j. As before, phase differences between ions in different devices can be compensated by local Z-rotations. However, for qubits within the same device, global microwave driving precludes this approach. Instead, we utilize a differential AC-Stark shift, enabled via optical inhomogeneity, to apply local Z rotations to these qubits (Methods Section D and E of the appendix, and ref. [40]). The phase-stabilized, three-qubit W-state, |W [symbol] =1/\sqrt{3}(|100 [symbol] +|010 [symbol] +|001 [symbol] ), was verified by measuring populations in 27 cardinal three-qubit Pauli bases along hood quantum state tomography to reconstruct the density matrix (FIG. 12c). With a photon acceptance window size of 300 ns, the resulting W-state generation rate and fidelity are measured to be R=2.0 Hz and F=0.592+/−0.007, respectively.

### Process Steps

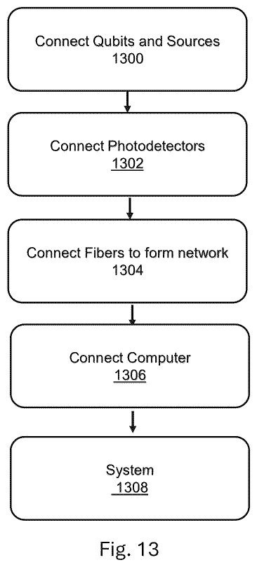

FIG. 9 and FIG. 13 illustrates a method for assembling or building a system 900 useful for quantum communication or quantum networking.

Block 1300 represents providing in a single device 902 or in each of a plurality of nodes 903:
1. a plurality of physical qubits 904 each having an energy level structure 906 comprising a ground state comprising a first level and a second level; and an excited state, wherein the physical qubits each have qubit levels comprising the first level and the second level of the ground state.
2. a source 908 of a first electromagnetic pulses (e.g., microwave or radio frequency pulses) electromagnetically coupled/connected to the physical qubits and tunable for coherently manipulating the qubits by driving a first transition between the first level and the second level. In one embodiment, the source comprises a local oscillator coupled to a frequency mixer. In another embodiment, an arbitrary wave generator (AWG) can be used to provide the microwave or RF output and/or can be used for controlling timing, sequence, duration and phase of pulses. However, a laser emitting pulses of the appropriate frequency for driving the first transition can be used, depending on the frequency (e.g., terahertz, infrared) of the first transition of the physical qubit.
3. a source 910 of second electromagnetic pulses comprising optical pulses electromagnetically coupled/connected to the physical qubits tunable for coherently manipulating the qubits by driving a second transition from the first level or the second level to the excited state. In one or more examples, the source comprises a laser emitting electromagnetic radiation at optical/telecommunication frequencies. The laser can be coupled to an AWG for controlling duration timing, sequence, and phase of pulses.

Block 1302 represents connecting one or more photodetectors 912 to the physical qubits for detecting photons 920 from the excited states of the different physical qubits with a timing resolution at least 10 times shorter than 1/Δf where Δf is the largest frequency separation between the second transitions of the physical qubits.

Block 1304 represents optionally providing one or more links comprising one or more optical fibers 914 connecting the nodes, each of the links further comprising a coupler 916 or beamsplitter for combining photons emitted from the excited states in a different one of the nodes.

Block 1306 represents connecting a computer 916 (e.g., circuit) operable to control execution of a protocol, the protocol comprising control of a sequence, timing, a phase and a duration of the pulses outputted from the sources in real time with detection of the single photons, and the protocol further comprising:
(a) one or more initialization pulses comprising at least one of the first electromagnetic pulses or the second electromagnetic pulses, for initializing each of the qubits into the first level or the second level;
(b) a plurality of the first electromagnetic pulses, each of the first electromagnetic pulses applied simultaneously to the first transition of a different one of the physical qubits so as to prepare an imbalanced superposition of the first level and the second level;
(c) a plurality of the second electromagnetic pulses, each of the second electromagnetic pulses applied simultaneously to a different one of the plurality of physical qubits to resonantly excite the second transition from the ground state to the excited state in each of the physical qubits in an attempt to entangle the different qubits to form entangled qubits;
(d) (i) recording detection of the single photon at one of the photodetectors to herald entanglement of a set of the physical qubits with an appropriate time stamp (t₀) during a heralding period, wherein the photodetector outputs the detection time t₀ of the single photon in response to the second pulses which may each have a predetermined transition frequency difference Δ\tilde{ω} from the second transition frequencies, or
   (ii) indicating no photon is detected at the of the photodetectors;
(e) a dynamic decoupling sequence comprising at least one of the first electromagnetic pulses and at least one of the second electromagnetic pulses applied in real time based on the previous recording of the time stamp to compensate for dephasing caused by non-static optical inhomogeneity of the physical qubits associated with stochastic emission of the photons;
(f) determining a quantum phase of a prepared Bell state φ=Δ\tilde{ω}t₀ to ascertain whether a correction of the quantum phase resulting from the predetermined transition frequency differences between the plurality of the physical qubits is necessary; and
(g) if the correction is necessary, instructing a phase compensation during a rephasing period comprising application of a differential z-rotation (phase shift) of the physical qubits by an amount φ, wherein the correction is determined and applied within a coherence time of the physical qubits and:
   (i) when the physical qubits are in the same device, the phase compensation comprises application of at least one of the first electromagnetic pulse or the second electromagnetic pulse, or
   (ii) when the physical qubits are in different nodes, the phase compensation comprises a phase change of the first electromagnetic pulses; and
(h) instructing readout and/or utilization of the entangled qubits.

Block 1308 represents the end result, a system for quantum networking or quantum communication.

Illustrative embodiments of the present invention include, but are not limited to, the following.
1. A computer system or computer implemented system for implementing a protocol in a quantum network or quantum communication system, comprising a computer having a memory; a processor executing on the computer; the memory storing a set of instructions, wherein the set of instructions, when executed by the processor cause the processor to perform operations comprising execution of a protocol comprising:
instructing one or more attempts at entanglement of physical qubits (e.g., each comprising qubit levels and a readout level) to form entangled qubits;
during a heralding period, recording an absence of a detection of a photon or the detection of a single photon heralding the entanglement, the detection at one or more detectors in response to a combination of photons emitted from the physical qubits in response to the attempt;
instructing application of a dynamic decoupling sequence to the physical qubits in real time with the detection to compensate for dephasing caused by non-static optical inhomogeneity of the physical qubits associated with stochastic emission of photons from the physical qubits;
if necessary, instructing application of a phase compensation to the physical qubits during a rephasing period to compensate for static inhomogeneity of the qubit levels in the different physical qubits; and
instructing readout and/or utilization of one or more of the entangled qubits.
2. The system of clause 1 further comprising the plurality of physical qubits each having an energy level structure comprising a ground state comprising a first level and a second level; and an excited state, wherein the physical qubits each have qubit levels comprising the first level and the second level of the ground state;
one or more sources of a first electromagnetic pulses (e.g., microwave pulses) tunable for coherently manipulating the physical qubits by driving a first transition between the first level and the second level;
one or more sources of second electromagnetic pulses comprising optical pulses tunable for coherently manipulating the qubits by driving a second transition from the first level or the second level to the excited state; and
one or more photodetectors coupled to the physical qubits for detecting a single photon in response to photons emitted from the excited states of the different physical qubits (e.g., with a timing resolution at least 10 times shorter than 1/Δf where Δf is the largest frequency separation between the second transitions of the physical qubits).
3. The system of any of the clauses 1-2 wherein the protocol comprises
(a) one or more initialization pulses comprising at least one of the first electromagnetic pulses or the second electromagnetic pulses, for initializing each of the qubits into the first level or the second level;
(b) a plurality of the first electromagnetic pulses, each of the first electromagnetic pulses applied simultaneously to the first transition of a different one of the physical qubits so as to prepare an imbalanced superposition of the first level and the second level;
(c) instructing the attempts at the entanglement, comprising instructing the output of a plurality of the second electromagnetic pulses, each of the second electromagnetic pulses applied simultaneously to a different one of the plurality of physical qubits to resonantly excite the second transition from the ground state to the excited state in each of the physical qubits in an attempt to entangle the different qubits to form entangled qubits;
(d) (i) recording the detection of the single photon at one of the photodetectors to herald entanglement of a set of the physical qubits with an appropriate time stamp (t₀) during a heralding period, wherein the photodetector outputs the detection time t₀ of the single photon in response to the second pulses which may each have a predetermined transition frequency difference Δ\tilde{ω} from the second transition frequencies, or
   (ii) recording no photon is detected at the of the photodetectors;
(e) instructing the dynamic decoupling sequence comprising at least one of the first electromagnetic pulses and at least one of the second electromagnetic pulses applied in real time based on the previous recording of the time stamp to compensate for dephasing caused by non-static optical inhomogeneity of the physical qubits associated with stochastic emission of the photons;
(f) determining a quantum phase of a prepared Bell state φ=Δ\tilde{ω}t₀ to ascertain whether a correction of the quantum phase resulting from the predetermined transition frequency differences between the plurality of the physical qubits is necessary; and
(g) if the correction is necessary, instructing the phase compensation during a rephasing period comprising application of a differential z-rotation (phase shift) of the physical qubits by an amount φ, wherein the correction is determined and applied within a coherence time of the physical qubits and:
   (i) when the physical qubits are in the same device, the phase compensation comprises application of at least one of the first electromagnetic pulse or the second electromagnetic pulse, or
   (ii) when the physical qubits are in different nodes, the phase compensation comprises a phase change of the first electromagnetic pulses; and
(h) instructing the readout and/or utilization of the entangled qubits.
4. The system of any of the clauses 1-3, comprising:
a plurality of nodes each comprising a different one of the set of the physical qubits to be entangled;
one or more links comprising one or more optical fibers connecting the nodes, each of the links further comprising a coupler or beamsplitter for combining photons emitted from the excited states in a different one of the nodes; and
the one or more photodetectors positioned after the coupler or beamsplitter for detecting the single photon in response to the combination of the photons emitted from the different nodes.
5. The system of any of the clauses 1-4 for multiplexing entanglement of N sets of the physical qubits, the N sets of the physical qubits comprising second transitions with different transition frequencies, where N is an integer greater than or equal to 2 and the protocol further comprises:
initializing the physical qubits in the N sets using steps (a) and (b);
for 2≤i≤N, exciting the second transitions in the ith one of the sets using step (c) in an attempt to entangle the ith one of the sets in an ith entangled state and performing a spin dynamical decoupling on the physical qubits between the exciting of the ith one of the sets and the next one of the sets; and
sequentially performing the step (d)-(f) on one or more of the sets until step (d) heralds the entanglement of one of the sets and instructing the quantum network in step (h) to use the entangled state of the one of the sets for which the step (d) heralds the entanglement, thereby increasing a rate at which the entangled qubits can be distributed in the network.
6. The system of any of the clauses 1-5, wherein the entangled qubits comprise more than two physical qubits and the protocol in steps (a)-(h) is used to herald the entanglement of the entangled qubits in (e.g., a W state) and comprising more than two physical qubits.
7. The system of any of the clauses 1-6, wherein the dynamic decoupling sequence comprises application of the pulses imparting a pre-compensated amount of phase constructed such that any phase accumulated during a second half of a given heralding period is cancelled by phase accumulated during a first half of a subsequent heralding period.
8. The system of any of the clauses 1-7, wherein the dynamic decoupling sequence applied to each of the physical qubits comprises:

$${[ τ - \tilde{π} - 2 τ - \tilde{π} - τ ]}^{N}$$

where \tilde{π} comprises the second electromagnetic pulse comprising a generalised π pulse tuned between the level in which the physical qubit was initialized and the excited state and applied simultaneously to each of the plurality of physical qubits, τ is an arbitrarily chosen decoupling time, a wait time between consecutive \tilde{π} pulses is 2τ, and N the number of times the dynamic decoupling sequence is repeated;
the heralding period is after odd numbers of the \tilde{π} pulses and the photodetector outputs the detection time t₀ of the single photon measured relative to a center of the heralding period, so that t₀∈[−τ,τ] for the second electromagnetic pulses having a predetermined transition frequency difference Δω=ω_{A,2}−ω_{A,1}−ω_{f,2}+ω_{f,1} where ω_{x,N} is the angular frequency for transition x of physical qubit N.
9. The system of clause 8, wherein generalized the \tilde{π} pulse comprises one of the second electromagnetic pulses exciting the second transition followed by one of the first electromagnetic pulses exciting the first transition followed by another one of the second electromagnetic pulses exciting the second transition and wherein all of the pulses are pi pulses.
10. The system of any of the clauses 1-9, wherein the excited state comprises a first excited level and a second excited level.
11. The system of clause 8 and 10, further comprising third electromagnetic pulses comprises pulses tunable to excite a third transition between the first excited level and the second excited level in each of the physical qubits, and wherein, for each of the physical qubits:
the generalized \tilde{π} pulse comprises:
   one of the second electromagnetic pulses exciting the second transition followed by application of M repetitions of the first and third electromagnetic pulses simultaneously applied to excite the first and third transitions, with time separation between the repetitions of 2T_{DD} and wherein a total duration 2MT_{DD} is longer than the optical lifetime of the excited state and M is odd; and
followed by one of the second electromagnetic pulses applied to the excite the second transition; and
wherein all the pulses are pi pulses.
12. The system of any of the clauses 1-10, wherein:
the single photon is detected during the heralding period of duration τ and are emitted randomly (according to an exponential distribution), with corresponding stochastic measurement time t₀ such that t₀∈[0,τ]; and
the dynamic decoupling sequence comprises applying rephasing pulses in real time and for a duration that depends on t₀.
13. The system of clause 1, wherein the dynamic decoupling sequence comprises:
14. a plurality of the first electromagnetic pulses applied simultaneously to a excite the first transitions of the plurality of the physical qubits so that the coherence is rephased for a duration (τ−t₀) in each of the physical qubits;
15. followed by the second electromagnetic pulses applied simultaneously to the second transitions of the plurality of the physical qubits, thereby transferring population from the ground state to the excited state in each of the physical qubits; and
16. after waiting for the duration t₀, applying the second electromagnetic pulses simultaneously to the second transitions so as to transfer population from the excited state back to ground state in each of the physical qubits, and
17, wherein all the pulses comprise pi pulses.
18. The system of any of the clauses 1-7, wherein the dynamic decoupling sequence comprises:
at least one of the first electromagnetic pulses between two of the second electromagnetic pulses or
one or more of the first electromagnetic pulses followed by at least two of the second electromagnetic pulses separated in time by t₀.
19. The system of any of the clauses 1-18, wherein the physical qubits are each located in physically separate devices or nodes and the phase is corrected by changing a phase of the first electromagnetic pulses independently applied to the qubits.
20. The system of any of the clauses 1-18, wherein the plurality of the physical qubits are located in the same device and the phase is corrected by application of the second electromagnetic pulses as to induce an AC stark shift of the second transitions.
21. The system of any of the clauses 1-20, wherein the dephasing corrected by the dynamic decoupling sequence are caused by frequency differences between the pulses outputted from different ones of the sources used to excite the different physical qubits.
22. A quantum network or quantum repeaters comprising the system of any of the clauses 1-19 or 21 wherein each of the physical qubits in the set are at different locations in the quantum network.
23. The system of any of the clauses 1-22, wherein the physical qubits comprise neutral trapped atoms, trapped ions, defects in a solid state host lattice, quantum dots, molecules, rare earth ions, or superconducting qubits.
24. The system of any of the clauses 1-22, wherein a variety of systems including, but not limited to, solid state materials, can be used to implement the qubits In one example, the system comprises a spin carrying defect (e.g., an ion or nitrogen vacancy) in a host lattice (e.g., a crystal), wherein the spin carrying defect comprises the qubit. Various rare earth doped crystals can be used. In one or more examples, the qubit ion comprising the qubit is Yb, Er, or Eu doped in a host crystal surrounding the qubit ion. Examples include, but are not limited to, Yb:YVO (as described in the first example), Er:Y₂SiO₅, or Eu:Y₂SiO₅). In another example, the system comprise a quantum dot in a host lattice, wherein the quantum dot (e.g., InGaAs or other semiconductor quantum dot) comprises the qubit and the host lattice is (e.g., InGaAs or other semiconductor).
25. The system or method of any of the clauses 1-24, wherein the dynamic in “dynamic decoupling sequence” means that we are adjusting things depending on the time stamp, or dynamical decoupling with predetermined pulse spacings.
26. The system of any of the clauses 1-25, wherein the protocol performs entanglement multiplexing comprising instructing the attempts at entanglement of 2 or more entangled qubits and only instructing readout and/or utilization of a first one of the entangled qubits for which the detection of the single photon heralds the entanglement.
27. The system of any of the clauses 1-26, wherein the protocol instructs the entanglement of more than 2 physical qubits.

### Method of Operating

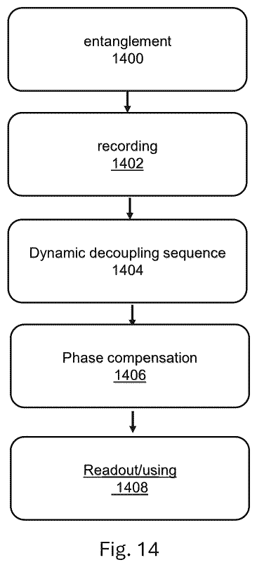

FIG. 14 is a flowchart illustrating a method for heralding entanglement in a quantum network or quantum communication system, comprising the following steps.

Block 1400 represents attempting entanglement of physical qubits to form entangled qubits.

Block 1402 represents, during a heralding period, recording an absence of a detection of a photon or the detection of a single photon heralding the entanglement, the detection at one or more detectors in response to a combination of photons emitted from the physical qubits in response to the attempt;

Block 1404 represents applying a dynamic decoupling sequence to the physical qubits in real time with the detection to compensate for dephasing caused by non-static optical inhomogeneity of the physical qubits associated with stochastic emission of photons from the physical qubits.

Block 1406 represents, if necessary, instructing application of a phase compensation to the physical qubits during a rephasing period to compensate for static inhomogeneity of the qubit levels in the different physical qubits; and

Block 1408 represents reading out a state of the entangled qubits and/or instructing use of the entangled qubits in a quantum networking or quantum communication application.

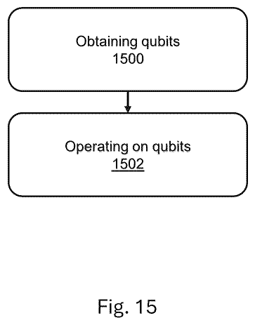

FIG. 15 illustrates a method for heralding entanglement in a quantum network or quantum communication system, comprising the following step.

Block 1500 represents obtaining a plurality of physical qubits each having an energy level structure comprising a ground state comprising a first level and a second level; and an excited state, wherein the physical qubits each have qubit levels comprising the first level and the second level of the ground state;

Block 1502 represents operating on the physical qubits using a protocol comprising:
(a) initializing the physical qubits with e.g., one or more initialization pulses comprising at least one of the first electromagnetic pulses or the second electromagnetic pulses, for initializing each of the qubits into the first level or the second level;
(b) preparing an unbalanced superposition of the first level and the second level by driving a first transition e.g., with a plurality of the first electromagnetic pulses, each of the first electromagnetic pulses applied simultaneously to the first transition of a different one of the physical qubits so as to prepare the imbalanced superposition of the first level and the second level;
(c) instructing the attempts at the entanglement, comprising instructing the output of a plurality of the second electromagnetic pulses, each of the second electromagnetic pulses applied simultaneously to a different one of the plurality of physical qubits to resonantly excite the second transition from the ground state to the excited state in each of the physical qubits in an attempt to entangle the different qubits to form entangled qubits;
(d) (i) recording/indicating the detection of the single photon at one of the photodetectors to herald entanglement of a set of the physical qubits with an appropriate time stamp (t₀) during a heralding period, wherein the photodetector outputs the detection time t₀ of the single photon in response to the second pulses which may each have a predetermined transition frequency difference Δ\tilde{ω} from the second transition frequencies, or
   (ii) Recording/indicating no photon is detected at the of the photodetectors;
(e) instructing the dynamic decoupling sequence comprising at least one of the first electromagnetic pulses and at least one of the second electromagnetic pulses applied in real time based on the previous recording of the time stamp to compensate for dephasing caused by non-static optical inhomogeneity of the physical qubits associated with stochastic emission of the photons;
(f) determining a quantum phase of a prepared Bell state φ=Δ\tilde{ω}t₀ to ascertain whether a correction of the quantum phase resulting from the predetermined transition frequency differences between the plurality of the physical qubits is necessary; and
(g) if the correction is necessary, instructing the phase compensation during a rephasing period comprising application of a differential z-rotation (phase shift) of the physical qubits by an amount φ, wherein the correction is determined and applied within a coherence time of the physical qubits and:
   (i) when the physical qubits are in the same device, the phase compensation comprises application of at least one of the first electromagnetic pulse or the second electromagnetic pulse, or
   (ii) when the physical qubits are in different nodes, the phase compensation comprises a phase change of the first electromagnetic pulses; and
(h) instructing the readout and/or utilization of the entangled qubits.

The methods of FIG. 14 or FIG. 15 can be implemented with the system of any of the applicable clauses 1-27.

### Applications

Example systems include quantum networks or repeaters implemented in quantum many-body systems with tailorable topology wherein nodes transmit, store and process quantum information and further comprising quantum channels interconnecting the nodes. The protocol can be implemented for short or long-range interactions/entanglement distribution. Example applications for the entangled qubits heralded using the protocol include, but are not limited to, quantum key distribution, distributed quantum computing, quantum simulation, quantum-enhanced sensing/metrology

### Advantages and Improvements

In this work, we have shown that multi-emitter nodes are a powerful tool for future quantum networks. They can scale the remote entanglement distribution rate through multiplexing, and enable the generation of more complex entangled states. This was achieved using a novel entanglement protocol that counteracts fluctuating optical frequency differences between emitters enabling efficient entanglement of any combination of distinguishable emitters. With technological advancements in detector timing resolution [51], we envisage application of this protocol to a broader range of solid state platforms with larger optical frequency separations.

By mitigating the three dominant sources of error in our platform we predict an increase in entangled state fidelity to [symbol] =0.883±0.004 (Supplementary Information Section VIII in the appendix). Specifically, photon emission from weakly coupled ions can be counteracted using YVO₄ samples with lower background concentrations of ¹⁷¹Yb, or host materials with fewer rare-earth impurities such as Silicon [29], CaWO₄ [31], or LiNbO₃ [27, 30]. Control errors originating from spontaneous emission during the optical π pulses can be mitigated using more laser power for larger 45 optical Rabi frequencies. Finally, undetected secondary spontaneous emission events that occur during the dynamic rephasing period destroy the coherence of our entangled state. These can be counteracted by temporarily extending the optical lifetime using a dynamically tun ₅₀ able cavity architecture, as demonstrated in several other

### Hardware Environment

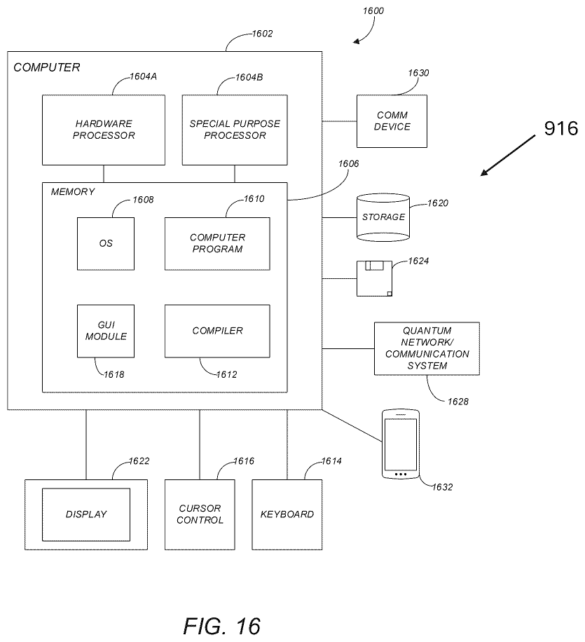

FIG. 16 is an exemplary hardware and software environment 1600 (referred to as a computer-implemented system and/or computer-implemented method) used to implement one or more embodiments of the invention (e.g., for implementing the protocol and/or controlling the sources and/or network 1628 as described herein). The hardware and software environment includes a computer 1602 and may include peripherals. Computer 1602 may be a user/client computer, server computer, or may be a database computer. The computer 1602 comprises a hardware processor 1604A and/or a special purpose hardware processor 1604B (hereinafter alternatively collectively referred to as processor 1604) and a memory 1606, such as random access memory (RAM). The computer 1602 may be coupled to, and/or integrated with, other devices, including input/output (I/O) devices such as a keyboard 1614, a cursor control device 1616 (e.g., a mouse, a pointing device, pen and tablet, touch screen, multi-touch device, etc.). In one or more embodiments, computer 1602 may be coupled to, or may comprise, a portable or media viewing/listening device 1632 (e.g., an MP3 player, IPOD, NOOK, portable digital video player, cellular device, personal digital assistant, etc.). In yet another embodiment, the computer 1602 may comprise a multi-touch device, mobile phone, gaming system, internet enabled television, television set top box, or other internet enabled device executing on various platforms and operating systems.

In one embodiment, the computer 1602 operates by the hardware processor 1604A performing instructions defined by the computer program 1610 (e.g., a quantum networking/communication application) under control of an operating system 1608. The computer program 1610 and/or the operating system 1608 may be stored in the memory 1606 and may interface with the user and/or other devices to accept input and commands and, based on such input and commands and the instructions defined by the computer program 1610 and operating system 1608, to provide output and results.

Output/results may be presented on the display 1622 or provided to another device for presentation or further processing or action. In one embodiment, the display 1622 comprises a liquid crystal display (LCD) having a plurality of separately addressable liquid crystals. Alternatively, the display 1622 may comprise a light emitting diode (LED) display having clusters of red, green and blue diodes driven together to form full-color pixels. Each liquid crystal or pixel of the display 1622 changes to an opaque or translucent state to form a part of the image on the display in response to the data or information generated by the processor 1604 from the application of the instructions of the computer program 1610 and/or operating system 1608 to the input and commands. The image may be provided through a graphical user interface (GUI) module 1618. Although the GUI module 1618 is depicted as a separate module, the instructions performing the GUI functions can be resident or distributed in the operating system 1608, the computer program 1610, or implemented with special purpose memory and processors.

In one or more embodiments, the display 1622 is integrated with/into the computer 1602 and comprises a multi-touch device having a touch sensing surface (e.g., track pod or touch screen) with the ability to recognize the presence of two or more points of contact with the surface. Examples of multi-touch devices include mobile devices (e.g., IPHONE, NEXUS S, DROID devices, etc.), tablet computers (e.g., IPAD, HP TOUCHPAD, SURFACE Devices, etc.), portable/handheld game/music/video player/console devices (e.g., IPOD TOUCH, MP3 players, NINTENDO SWITCH, PLAYSTATION PORTABLE, etc.), touch tables, and walls (e.g., where an image is projected through acrylic and/or glass, and the image is then backlit with LEDs).

Some or all of the operations performed by the computer 1602 according to the computer program 1610 instructions may be implemented in a special purpose processor 1604B. In this embodiment, some or all of the computer program 1610 instructions may be implemented via firmware instructions stored in a read only memory (ROM), a programmable read only memory (PROM) or flash memory within the special purpose processor 1604B or in memory 1606. The special purpose processor 1604B may also be hardwired through circuit design to perform some or all of the operations to implement the present invention. Further, the special purpose processor 1604B may be a hybrid processor, which includes dedicated circuitry for performing a subset of functions, and other circuits for performing more general functions such as responding to computer program 1610 instructions. In one embodiment, the special purpose processor 1604B is an application specific integrated circuit (ASIC) or field programmable gate array (FPGA).

The computer 1602 may also implement a compiler 1612 that allows an application or computer program 1610 written in a programming language such as C, C++, Assembly, SQL, PYTHON, PROLOG, MATLAB, RUBY, RAILS, HASKELL, or other language to be translated into processor 1604 readable code. Alternatively, the compiler 1612 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 1610 accesses and manipulates data accepted from I/O devices and stored in the memory 1606 of the computer 1602 using the relationships and logic that were generated using the compiler 1612.

The computer 1602 also optionally comprises an external communication device such as a modem, satellite link, Ethernet card, or other device for accepting input from, and providing output to, other computers 1602.

In one embodiment, instructions implementing the operating system 1608, the computer program 1610, and the compiler 1612 are tangibly embodied in a non-transitory computer-readable medium, e.g., data storage device 1620, which could include one or more fixed or removable data storage devices, such as a zip drive, floppy disc drive 1624, hard drive, CD-ROM drive, tape drive, etc. Further, the operating system 1608 and the computer program 1610 are comprised of computer program 1610 instructions which, when accessed, read and executed by the computer 1602, cause the computer 1602 to perform the steps necessary to implement and/or use the present invention or to load the program of instructions into a memory 1606, thus creating a special purpose data structure causing the computer 1602 to operate as a specially programmed computer executing the method steps described herein. Computer program 1610 and/or operating instructions may also be tangibly embodied in memory 1606 and/or data communications devices 1630, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 1602.

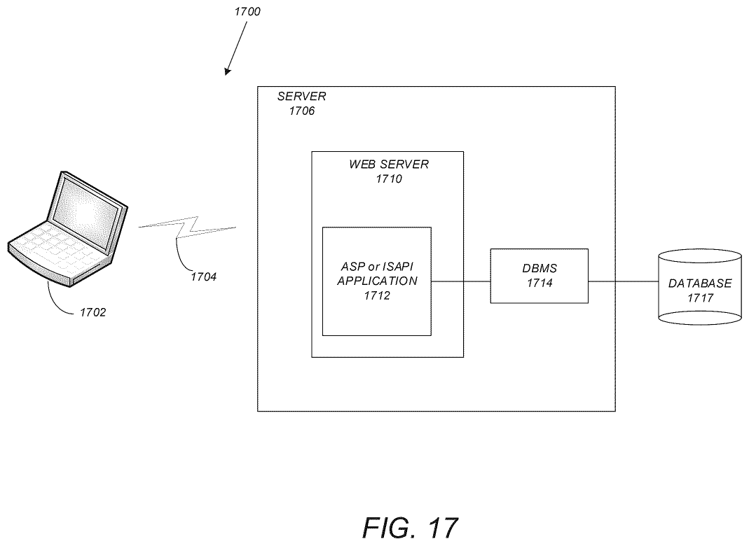

FIG. 17 schematically illustrates a typical distributed/cloud-based computer system 1700 using a network 1704 to connect client computers 1702 to server computers 1706. A typical combination of resources may include a network 1704 comprising the Internet, LANs (local area networks), WANs (wide area networks), SNA (systems network architecture) networks, or the like, clients 1702 that are personal computers or workstations (as set forth in FIG. 16), and servers 1706 that are personal computers, workstations, minicomputers, or mainframes (as set forth in FIG. 16). However, it may be noted that different networks such as a cellular network (e.g., GSM [global system for mobile communications] or otherwise), a satellite based network, or any other type of network may be used to connect clients 1702 and servers 1706 in accordance with embodiments of the invention.

A network 1704 such as the Internet connects clients 1702 to server computers 1706. Network 1704 may utilize ethernet, coaxial cable, wireless communications, radio frequency (RF), etc. to connect and provide the communication between clients 1702 and servers 1706. Further, in a cloud-based computing system, resources (e.g., storage, processors, applications, memory, infrastructure, etc.) in clients 1702 and server computers 1706 may be shared by clients 1702, server computers 1706, and users across one or more networks. Resources may be shared by multiple users and can be dynamically reallocated per demand. In this regard, cloud computing may be referred to as a model for enabling access to a shared pool of configurable computing resources.

Clients 1702 may execute a client application or web browser and communicate with server computers 1706 executing web servers 1710. Such a web browser is typically a program such as MICROSOFT INTERNET EXPLORER/EDGE, MOZILLA FIREFOX, OPERA, APPLE SAFARI, GOOGLE CHROME, etc. Further, the software executing on clients 1702 may be downloaded from server computer 1706 to client computers 1702 and installed as a plug-in or ACTIVEX control of a web browser. Accordingly, clients 1702 may utilize ACTIVEX components/component object model (COM) or distributed COM (DCOM) components to provide a user interface on a display of client 1702. The web server 1710 is typically a program such as MICROSOFT'S INTERNET INFORMATION SERVER.

Web server 1710 may host an Active Server Page (ASP) or Internet Server Application Programming Interface (ISAPI) application 1712, which may be executing scripts. The scripts invoke objects that execute business logic (referred to as business objects). The business objects then manipulate data in database 1716 through a database management system (DBMS) 1714. Alternatively, database 1716 may be part of, or connected directly to, client 1702 instead of communicating/obtaining the information from database 1716 across network 1704. When a developer encapsulates the business functionality into objects, the system may be referred to as a component object model (COM) system. Accordingly, the scripts executing on web server 1710 (and/or application 1712) invoke COM objects that implement the business logic. Further, server 1706 may utilize MICROSOFT'S TRANSACTION SERVER (MTS) to access required data stored in database 1716 via an interface such as ADO (Active Data Objects), OLE DB (Object Linking and Embedding DataBase), or ODBC (Open DataBase Connectivity).

Generally, these components 1700-1716 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 1702 and 1706 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 1702 and 1706. Embodiments of the invention are implemented as a software/quantum networking communication application on a client 1702 or server computer 1706. Further, as described above, the client 1702 or server computer 1706 may comprise a thin client device or a portable device that has a multi-touch-based display.

### REFERENCES

The following references are incorporated by reference herein.
[1] Gottesman, D., Jennewein, T. & Croke, S. Longer-560 baseline telescopes using quantum repeaters. Phys. Rev. ₅₆₁ Lett. 109, 070503 (2012).
[2] Kómár, P. et al. A quantum network of clocks. Nat. 563 Phys. 10, 582-587 (2014).
[3] Ekert, A. & Renner, R. The ultimate physical limits of 565 privacy. Nature 507, 443-447 (2014).
[4] Jiang, L., Taylor, J. M., Sorensen, A. S. & Lukin, M. D. 567 Distributed quantum computation based on small quan-₅₆₈ tum registers. Phys. Rev. A 76, 062323 (2007).
[5] Stephenson, L. J. et al. High-rate, high-fidelity entangle-570 ment of qubits across an elementary quantum network. 571 Phys. Rev. Lett. 124, 110501 (2020).
[6] Krutyanskiy, V. et al. Entanglement of Trapped-Ion 573 Qubits Separated by 230 Meters. Phys. Rev. Lett. 130, 574 50803 (2023).
[7] Daiss, S. et al. A quantum-logic gate between distant 576 quantum-network modules. Science 371, 614-617 (2021). 577
[8] van Leent, T. et al. Entangling single atoms over 33 km ₅₇ telecom fibre. Nature 607, 69-73 (2022).
[9] Jing, B. et al. Entanglement of three quantum memories 580 via interference of three single photons. Nat. Photonics 581 13, 210-213 (2019).
[10] Lago-Rivera, D., Grandi, S., Rakonjac, J. V., Seri, A. & 583 de Riedmatten, H. Telecom-heralded entanglement be-₅₈₄ tween multimode solid-state quantum memories. Nature 585 594, 37-40 (2021).
[11] Liu, X. et al. Heralded entanglement distribution be-₅₈₇⁵⁸⁷ tween two absorptive quantum memories. Nature 594, ₅₈₈ 41-45 (2021).
[12] Pompili, M. et al. Realization of a multinode quantum 590 network of remote solid-state qubits. Science 372, 259-₅₉₁ 264 (2021).
[13] Delteil, A. et al. Generation of heralded entanglement be-593 tween distant hole spins. Nat. Phys. 12, 218-223 (2016). ₅₉₄
[14] Knaut, C. M. et al. Entanglement of nanophotonic quan-595 tum memory nodes in a telecom network. Nature 629, 596 573-578(2024).
[15] Zaporski, L. et al. Ideal refocusing of an optically ac-598 tive spin qubit under strong hyperfine interactions. Nat. 599 Nanotechnol. 18, 257-263 (2023).
[16] Christle, D. J. et al. Isolated electron spins in silicon 60 carbide with millisecond coherence times. Nat. Mater. 602 14, 160-163 (2015).
[17] Lukin, D. M., Guidry, M. A. & Vučković, J. Integrated ₆₀₄⁶⁰³ quantum photonics with silicon carbide: Challenges and 605 prospects. PRX Quantum 1, 020102 (2020).
[18] Higginbottom, D. B. et al. Optical observation of single 60 spins in silicon. Nature 607, 266-270 (2022).
[19] Komza, L. et al. Indistinguishable photons from an arti-6 ficial atom in silicon photonics. Nature Communications 610 15, 6920 (2024).
[20] Bayliss, S. L. et al. Optically addressable molecular spins 612 for quantum information processing. Science 370, 13091312 (2020).
[21] Rose, B. C. et al. Observation of an environmentally 615 insensitive solid-state spin defect in diamond. Science 616 361, 60-63 (2018).
22] Arjona Martinez, J. et al. Photonic indistinguishability of 618 the tin-vacancy center in nanostructured diamond. Phys. ₆₁₉ Rev. Lett. 129, 173603 (2022).
[23] Senkalla, K., Genov, G., Metsch, M. H., Siyushev, P. & ⁶²¹ Jelezko, F. Germanium vacancy in diamond quantum 622 memory exceeding 20 ms. Phys. Rev. Lett. 132, 026901 ₆₂₃ (2024).
[24] Rosenthal, E. I. et al. Microwave spin control of a tin-62 vacancy qubit in diamond. Phys. Rev. X 13, 31022 (2023).
[25] Utikal, T. et al. Spectroscopic detection and state preparation of a single praseodymium ion in a crystal. Nat. Commun. 5, 3627 (2014).
[26] Kindem, J. M. et al. Control and single-shot readout of an ion embedded in a nanophotonic cavity. Nature 580, 201-204 (2020).
[27] Xia, K. et al. Tunable microcavities coupled to rare-earth quantum emitters. Optica 9, 445-450 (2022).
[28] Deshmukh, C. et al. Detection of single ions in a nanoparticle coupled to a fiber cavity. Optica 10, 1339-1344 (2023).
[29] Gritsch, A., Ulanowski, A. & Reiserer, A. Purcell enhancement of single-photon emitters in silicon. Optica 10, 783-789 (2023).
[30] Yang, L., Wang, S., Shen, M., Xie, J. & Tang, H. X. Controlling single rare earth ion emission in an electrooptical nanocavity. Nat. Commun. 14, 1718 (2023).
[31] Uysal, M. T. et al. Spin-photon entanglement of a single Er³⁺ ion in the telecom band Preprint at https://arxiv org/abs/2406 06515 (2024).
[32] Simon, C. et al. Quantum repeaters with photon pair sources and multimode memories. Phys. Rev. Lett. 98, 190503 (2007).
[33] van Dam, S. B., Humphreys, P. C., Rozpedek, F., Wehner, S. & Hanson, R. Multiplexed entanglement generation over quantum networks using multi-qubit nodes. Quantum Science and Technology 2, 034002 (2017).
[34] Lipinska, V., Murta, G. & Wehner, S. Anonymous transmission in a noisy quantum network using the W state. Phys. Rev. A 98, 052320 (2018).
[35] D'Hondt, E. & Panangaden, P. The computational power of the W and GHZ states. Quantum Inf. Comput. 6, 173183 (2005).
[36] Lago-Rivera, D., Rakonjac, J. V., Grandi, S. & de Riedmatten, H. Long distance multiplexed quantum teleportation from a telecom photon to a solid-state qubit. Nat. Commun. 14, 1889 (2023).
[37] Krutyanskiy, V., Canteri, M., Meraner, M., Krcmarsky, V. & Lanyon, B. Multimode ion-photon entanglement over 101 kilometers. PRX Quantum 5, 020308 (2024).
[38] Hartung, L., Seubert, M., Welte, S., Distante, E. & Rempe, G. A quantum-network register assembled with optical tweezers in an optical cavity. Science 385, 179183 (2024).
[39] Maurer, P. C. et al. Far-field optical imaging and manipulation of individual spins with nanoscale resolution. Nat. Phys. 6, 912-918 (2010).
[40] Chen, S., Raha, M., Phenicie, C. M., Ourari, S. & Thompson, J. D. Parallel single-shot measurement and coherent control of solid-state spins below the diffraction limit. Science 370, 592-595 (2020).
[41] Vittorini, G., Hucul, D., Inlek, I. V., Crocker, C. & Monroe, C. Entanglement of distinguishable quantum memories. Phys. Rev. A 90, 1-5 (2014).
[42] Kindem, J. M. et al. Characterization of ¹⁷¹Yb³⁺:YVO₄ for photonic quantum technologies. Phys. Rev. B 98, 24404 (2018).
[43] Ruskuc, A., Wu, C.-J., Rochman, J., Choi, J. & Faraon, A. Nuclear spin-wave quantum register for a solid state qubit. Nature 602, 408-413 (2022)
[44] Merkel, B., Ulanowski, A. & Reiserer, A. Coherent and Purcell-Enhanced Emission from Erbium Dopants in a Cryogenic High-Q Resonator. Phys. Rev. X 10, 041025 (2020).
[45] Ulanowski, A., Fruh, J., Salamon, F., Holzapfel, A. & Reiserer, A. Spectral Multiplexing of Rare-Earth Emitters in a Co-Doped Crystalline Membrane. Advanced Optical Materials 12, 2302897 (2024).
[46] Cabrillo, C., Cirac, J. I., García-Fernández, P. & Zoller, P. Creation of entangled states of distant atoms by interference. Phys. Rev. A 59, 1025-1033 (1999).
[47] Hermans, S. L. N. et al. Entangling remote qubits using the single-photon protocol: an in-depth theoretical and experimental study. New J. Phys. 25, 013011 (2023).
[48] James, D. F. V., Kwiat, P. G., Munro, W. J. & White, A. G. Measurement of qubits. Phys. Rev. A 64, 52312 (2001).
[49] Barrett, S. D. & Kok, P. Efficient high-fidelity quantum computation using matter qubits and linear optics. Phys. Rev. A 71, 2-5 (2005).
[50] Miguel-Ramiro, J., Riera-Sabat, F. & Dur, W. Quantum repeater for W states. PRX Quantum 4, 040323 (2023).
51] Korzh, B. et al. Demonstration of sub-3 ps temporal resolution with a superconducting nanowire single-photon detector. Nat. Photonics 14, 250-255 (2020).
[52] Casabone, B. et al. Dynamic control of Purcell enhanced emission of erbium ions in nanoparticles. Nature Communications 12, 3570 (2021).
[53] Yu, Y. et al. Frequency Tunable, Cavity-Enhanced Single Erbium Quantum Emitter in the Telecom Band. Phys. Rev. Lett. 131, 170801 (2023).
[54] Stolk, A. J. et al. Metropolitan-scale heralded entanglement of solid-state qubits. Preprint at https://arviv.org/404.03723 (2024).
[55] Uysal, M. T. & Thompson, J. D. Rephasing spectral diffusion in time-bin spin-spin entanglement protocols Preprint at https://arxiv.org/abs/2406 06497 (2024).
[56] Scalable Multipartite Entanglement of Remote Rare-earth Ion Qubits Andrei Ruskuc, Chun-Jo Wu, Emanuel Green, Sophie L. N. Hermans, Joonhee Choi, Andrei Faraon available at https://arxiv.org/abs/2402.16224

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

### APPENDICES

The present disclosure includes Appendix A, the entire contents of which is incorporated herein for all purposes and is considered part of this disclosure.

What is claimed is:

1. A system:
a plurality of physical qubits each having an energy level structure comprising a ground state comprising a first level and a second level; and an excited state, wherein the physical qubits each have qubit levels comprising the first level and the second level of the ground state;
one or more sources of a first electromagnetic pulses tunable for coherently manipulating the qubits by driving a first transition between the first level and the second level;
one or more sources of second electromagnetic pulses comprising optical pulses tunable for coherently manipulating the qubits by driving a second transition from the first level or the second level to the excited state; and
one or more photodetectors coupled to the physical qubits for detecting a single photon in response to photons emitted from the excited states of the different physical qubits;
a circuit operable to control execution of a protocol, the protocol comprising control of a sequence, timing, a phase and a duration of the pulses outputted from the sources in real time with detection of the single photons, and the protocol further comprising:
(a) one or more initialization pulses comprising at least one of the first electromagnetic pulses or the second electromagnetic pulses, for initializing each of the qubits into the first level or the second level;
(b) a plurality of the first electromagnetic pulses, each of the first electromagnetic pulses applied simultaneously to the first transition of a different one of the physical qubits so as to prepare an imbalanced superposition of the first level and the second level;
(c) a plurality of the second electromagnetic pulses, each of the second electromagnetic pulses applied simultaneously to a different one of the plurality of physical qubits to resonantly excite the second transition from the ground state to the excited state in each of the physical qubits in an attempt to entangle the different qubits to form entangled qubits;
(d) (i) recording detection of the single photon at one of the photodetectors to herald entanglement of a set of the physical qubits with an appropriate time stamp (t₀) during a heralding period, wherein the photodetector outputs the detection time t₀ of the single photon in response to the second pulses which may each have a predetermined transition frequency difference Δ\tilde{ω} from the second transition frequencies, or
(ii) indicating no photon is detected at the of the photodetectors;
(e) a dynamic decoupling sequence comprising at least one of the first electromagnetic pulses and at least one of the second electromagnetic pulses applied in real time based on the previous recording of the time stamp to compensate for dephasing caused by non-static optical inhomogeneity of the physical qubits associated with stochastic emission of the photons;
(f) determining a quantum phase of a prepared Bell state φ=Δ\tilde{ω}t₀ to ascertain whether a correction of the quantum phase resulting from the predetermined transition frequency differences between the plurality of the physical qubits is necessary;
(g) if the correction is necessary, instructing a phase compensation during a rephasing period comprising application of a differential z-rotation (phase shift) of the physical qubits by an amount φ, wherein the correction is determined and applied within a coherence time of the physical qubits and:
(i) when the physical qubits are in the same device, the phase compensation comprises application of at least one of the first electromagnetic pulse or the second electromagnetic pulse, or
(ii) when the physical qubits are in different nodes, the phase compensation comprises a phase change of the first electromagnetic pulses; and
(h) instructing readout and/or utilization of the entangled qubits.

2. The system of claim 1, comprising:
qubits to be entangled;
one or more links comprising one or more optical fibers connecting the nodes, each of the links further comprising a coupler or beamsplitter for combining photons emitted from the excited states in a different one of the nodes; and
the one or more photodetectors positioned after the coupler or beamsplitter for detecting the single photon in response to the combination of the photons emitted from the different nodes.

3. The system of claim 1 for multiplexing entanglement of N sets of the physical qubits, the N sets of the physical qubits comprising second transitions with different transition frequencies, where N is an integer greater than or equal to 2 and the protocol further comprises:
initializing the physical qubits in the N sets using steps (a) and (b);
for 2≤i≤N, exciting the second transitions in the ith one of the sets using step (c) in an attempt to entangle the ith one of the sets in an ith entangled state and performing a spin dynamical decoupling on the physical qubits between the exciting of the ith one of the sets and the next one of the sets; and
sequentially performing the step (d)-(g) on one or more of the sets until step (d) heralds the entanglement of one of the sets and instructing the quantum network in step (h) to use the entangled state of the one of the sets for which the the step (d) heralds the entanglement, thereby increasing a rate at which the entangled qubits can be distributed in the network.

4. The system of claim 1, wherein the entangled qubits comprise more than two physical qubits and the protocol in steps (a)-(h) is used to herald the entanglement of the entangled qubits in a W state and comprising more than two physical qubits.

5. The system of claim 1, wherein the dynamic decoupling sequence comprises application of the pulses imparting a pre-compensated amount of phase constructed such that any phase accumulated during a second half of a given heralding period is cancelled by phase accumulated during a first half of a subsequent heralding period.

6. The system of claim 1, wherein the dynamic decoupling sequence applied to each of the physical qubits comprises:
$${[ τ - \tilde{π} - 2 τ - \tilde{π} - τ ]}^{N}$$
where \tilde{π} comprises the second electromagnetic pulse comprising a generalised π pulse tuned between the level in which the physical qubit was initialized and the excited state and applied simultaneously to each of the plurality of physical qubits, τ is an arbitrarily chosen decoupling time, a wait time between consecutive \tilde{π} pulses is 2τ, and N the number of times the dynamic decoupling sequence is repeated;
the heralding period is after odd numbers of the \tilde{π} pulses and the photodetector outputs the detection time t₀ of the single photon measured relative to a center of the heralding period, so that t₀∈[−τ,τ] for the second electromagnetic pulses having a predetermined transition frequency difference Δω=ω_{A,2}−ω_{A,1}−ω_{f,2}+ω_{f,1} where ω_{x,N} is the angular frequency for transition x of physical qubit N.

7. The system of claim 6, wherein generalized the \tilde{π} pulse comprises one of the second electromagnetic pulses exciting the second transition followed by one of the first electromagnetic pulses exciting the first transition followed by another one of the second electromagnetic pulses exciting the second transition and wherein all of the pulses are pi pulses.

8. The system of claim 6, wherein the excited state comprises a first excited level and a second excited level.

9. The system of claim 8, further comprising third electromagnetic pulses comprises pulses tunable to excite a third transition between the first excited level and the second excited level in each of the physical qubits, and wherein, for each of the physical qubits:
the generalized \tilde{π} pulse comprises:
one of the second electromagnetic pulses exciting the second transition followed by application of M repetitions of the first and third electromagnetic pulses simultaneously applied to excite the first and third transitions, with time separation between the repetitions of 2T_{DD} and wherein a total duration 2MT_{DD} is longer than the optical lifetime of the excited state and M is odd; and
followed by one of the second electromagnetic pulses applied to the excite the second transition; and
wherein all the pulses are pi pulses.

10. The system of claim 1, wherein:
the single photon is detected during the heralding period of duration τ and are emitted randomly (according to an exponential distribution), with corresponding stochastic measurement time t₀ such that t₀∈[0,τ]; and
the dynamic decoupling sequence comprises applying rephasing pulses in real time and for a duration that depends on t₀.

11. The system of claim 1, wherein the dynamic decoupling sequence comprises:
a plurality of the first electromagnetic pulses applied simultaneously to a excite the first transitions of the plurality of the physical qubits so that the coherence is rephased for a duration (τ−t₀) in each of the physical qubits;
followed by the second electromagnetic pulses applied simultaneously to the second transitions of the plurality of the physical qubits, thereby transferring population from the ground state to the excited state in each of the physical qubits; and
after waiting for the duration t₀, applying the second electromagnetic pulses simultaneously to the second transitions so as to transfer population from the excited state back to ground state in each of the physical qubits, and
wherein all the pulses comprise pi pulses.

12. The system of claim 1, wherein the dynamic decoupling sequence comprises:
at least one of the first electromagnetic pulses between two of the second electromagnetic pulses or
one or more of the first electromagnetic pulses followed by at least two of the second electromagnetic pulses separated in time by t₀.

13. The system of claim 1, wherein the physical qubits are each located in physically separate devices or nodes and the phase is corrected by changing a phase of the first electromagnetic pulses independently applied to the qubits.

14. The system of claim 1, wherein the plurality of the qubits are located in the same device and the phase is corrected by application of the second electromagnetic pulses as to induce an AC stark shift of the second transitions.

15. The system of claim 1, wherein the dephasing corrected by the dynamic decoupling sequence are caused by frequency differences between the pulses outputted from different ones of the sources used to excite the different physical qubits.

16. A quantum network or quantum repeaters comprising the system of claim 1, wherein each of the physical qubits in the set are at different locations in the quantum network.

17. The system of claim 1, wherein the qubits comprise neutral trapped atoms, trapped ions, defects in a solid state host lattice, quantum dots, molecules, rare earth ions, or superconducting qubits.

18. A computer system for implementing a protocol in a quantum network or quantum communication system, comprising:
a computer having a memory;
a processor executing on the computer;
the memory storing a set of instructions, wherein the set of instructions, when executed by the processor cause the processor to perform operations comprising execution of a protocol comprising:
instructing one or more attempts at entanglement of physical qubits to form entangled qubits;
during a heralding period, recording an absence of a detection of a photon or the detection of a single photon heralding the entanglement, the detection at one or more detectors in response to a combination of photons emitted from the physical qubits in response to the attempt;
instructing application of a dynamic decoupling sequence to the physical qubits in real time with the detection to compensate for dephasing caused by non-static optical inhomogeneity of the physical qubits associated with stochastic emission of photons from the physical qubits;
if necessary, instructing application of a phase compensation to the physical qubits during a rephasing period to compensate for static inhomogeneity of the qubit levels in the different physical qubits; and
instructing readout and/or utilization of one or more of the entangled qubits.

19. The system of claim 18, wherein the protocol:
performs entanglement multiplexing comprising instructing the attempts at entanglement of 2 or more entangled qubits and only instructing readout and/or utilization of a first one of the entangled qubits for which the detection of the single photon heralds the entanglement; and/or
instructs the entanglement of more than 2 physical qubits.

20. A method for heralding entanglement in a quantum network or quantum communication system, comprising:
attempting entanglement of physical qubits to form entangled qubits;
during a heralding period, recording an absence of a detection of a photon or the detection of a single photon heralding the entanglement, the detection at one or more detectors in response to a combination of photons emitted from the physical qubits in response to the attempt;
applying a dynamic decoupling sequence to the physical qubits in real time with the detection to compensate for dephasing caused by non-static optical inhomogeneity of the physical qubits associated with stochastic emission of photons from the physical qubits;
if necessary, instructing application of a phase compensation to the physical qubits during a rephasing period to compensate for static inhomogeneity of the qubit levels in the different physical qubits; and
reading out a state of the entangled qubits and/or instructing use of the entangled qubits in a quantum networking or quantum communication application.
